(19) United States
(12) Patent Application Publication
(10) Pub. No.: US 2026/0122378 A1
(43) Pub. Date: Apr. 30, 2026

(54) IMAGE SENSOR AND DRIVING METHOD THEREOF

(71) Applicant: Samsung Electronics Co., Ltd., Suwon-si (KR)

(72) Inventors: Sanggwon Lee, Suwon-si (KR); Minwoong Seo, Suwon-si (KR); Heesung Shim, Suwon-si (KR)

(21) Appl. No.: 19/290,241

(22) Filed: Aug. 4, 2025

(30) Foreign Application Priority Data
Oct. 28, 2024 (KR) 10-2024-0148694

(51) Int. Cl. H04N 25/78; H04N 25/51; H04N 25/532; H04N 25/616; H04N 25/771

(52) U.S. Cl. CPC H04N 25/78; H04N 25/51; H04N 25/771; H04N 25/532; H04N 25/616

(57) ABSTRACT

An image sensor includes a photoelectric device configured to generate a photoelectric charge, a first node configured to accumulate the photoelectric charge generated from the first photoelectric device, a first transmission transistor connected between the first node and the first photoelectric device, a first reset transistor connected between the first node and a power supply voltage, a first drain transistor connected between photoelectric device and a power supply voltage, and a driving transistor configured to generate a pixel signal in response to a voltage of the first node, wherein the driving transistor generates a first pixel signal while the first transmission transistor is turned off, and generates a second pixel signal after the first transmission transistor is turned on, and the first drain transistor is turned on while the driving transistor generates the first pixel signal.

### CROSS-REFERENCE TO RELATED APPLICATION

This application claims priority to Korean Patent Application No. 10-2024-0148694, filed in the Korean Intellectual Property Office on Oct. 28, 2024, the disclosure of which is incorporated herein by reference in its entirety.

### BACKGROUND

An image sensor is a device that captures a 2D or 3D image of an object. The image sensor creates an image of the object using a photoelectric conversion device that reacts according to intensity of light reflected from the object. Recently, with the advancement of complementary metal-oxide semiconductor (CMOS) technology, CMOS image sensors using CMOS are being widely used.

Meanwhile, a shutter speed of the image sensor is important for accurate capture of high-speed subjects. In particular, when using an image sensor that operates as a global shutter, a high shutter speed is required to minimize distortion due to subject movement.

### SUMMARY

In general, in some aspects, the present disclosure is directed toward an image sensor with improved reliability.

According to some implementations, the present disclosure is directed to an image sensor that includes a photoelectric device configured to generate a photoelectric charge, a first node configured to accumulate the photoelectric charge generated from the first photoelectric device, a first transmission transistor connected between the first node and the first photoelectric device, a first reset transistor connected between the first node and a power supply voltage, a first drain transistor connected between photoelectric device and a power supply voltage, and a driving transistor configured to generate a pixel signal in response to a voltage of the first node, wherein the driving transistor generates a first pixel signal while the first transmission transistor is turned off, and generates a second pixel signal after the first transmission transistor is turned on, and the first drain transistor is turned on while the driving transistor generates the first pixel signal.

According to some implementations, the present disclosure is directed to an image sensor that includes a first photoelectric device configured to generate a photoelectric charge, a first node configured to accumulate the photoelectric charge generated from the first photoelectric device, a first transmission transistor connected between the first node and the photoelectric device, a first reset transistor connected between the first node and a power supply voltage, a first drain transistor connected between first photoelectric device and a power supply voltage, a driving transistor configured to generate a pixel signal in response to a voltage of the first node and output the pixel signal to the first output node, a first sampling capacitor connected to the first output node to store a charge corresponding to the pixel signal, and a first sampling transistor connected between the first sampling capacitor and the first output node, wherein the driving transistor generates a first pixel signal while the first transmission transistor is turned off, and generates a second pixel signal after the first transmission transistor is turned on, and the first drain transistor is turned on while the first sampling capacitor stores charge corresponding to the first pixel signal.

According to some implementations, the present disclosure is directed to an image sensor that includes a pixel comprising a first photoelectric device configured to generate a photoelectric charge, a first node configured to accumulate the photoelectric charge generated by the first photoelectric device, a first transmission transistor connected between the first node and the first photoelectric device, a first reset transistor connected between the first node and a power supply voltage a first drain transistor connected between the first photoelectric device and the power supply voltage, and a driving transistor configured to generate a pixel signal in response to a voltage of the first node to output the pixel signal to the first output node, a ramp signal generator configured to generate a reference signal including a plurality of ramp signals, and a readout circuit connected to the first output node and configured to compare the pixel signal and the reference signal, and configured to generate image data based on a comparison result thereof, wherein the driving transistor generates a first pixel signal while the first transmission transistor is turned off, and generates a second pixel signal after the first transmission transistor is turned on, and the first drain transistor is turned on while the readout circuit generates first image data corresponding to the first pixel signal.

### BRIEF DESCRIPTION OF THE DRAWINGS

Example implementations will be more clearly understood from the following detailed description, taken in conjunction with the accompanying drawings.

FIG. 1 illustrates a block diagram of an example of an image sensor according to some implementations.

FIG. 2 illustrates a circuit diagram showing examples of a pixel and a readout circuit according to some implementations.

FIG. 3 illustrates a timing diagram showing an example of an operation of an image sensor including the pixel according to FIG. 2 according to some implementations.

FIG. 4 illustrates a circuit diagram showing an example of a pixel according to some implementations.

FIG. 5 illustrates a circuit diagram showing an example of a pixel according to some implementations.

FIG. 6 illustrates a timing diagram showing an example of an operation of the pixel according to FIG. 5 according to some implementations.

FIG. 7 illustrates an example of a change in potential level of each channel region within the change in potential level of each channel pixel according to FIG. 5 according to some implementations.

FIG. 8 illustrates a circuit diagram showing examples of a pixel and a readout circuit according to some implementations.

FIG. 9 illustrates a timing diagram showing an example of an operation of an image sensor according to FIG. 8 according to some implementations.

FIG. 10 illustrates a timing diagram showing an example of an operation of an image sensor according to FIG. 8 according to some implementations.

FIG. 11 illustrates a timing diagram showing an example of an operation of an image sensor according to FIG. 8 according to some implementations.

FIG. 12 illustrates an example of a pixel according to some implementations.

FIG. 13 illustrates a circuit diagram showing an example of a pixel according to some implementations.

FIG. 14 illustrates a timing diagram showing an example of an operation of the pixel according to FIG. 13 according to some implementations.

FIG. 15 illustrates a circuit diagram showing examples of a pixel and a readout circuit according to some implementations.

FIG. 16 illustrates an example of a pixel according to some implementations.

FIG. 17 illustrates an example of a pixel according to some implementations.

FIG. 18 illustrates a timing diagram showing an example of an operation of the pixel according to FIG. 17 according to some implementations.

FIG. 19 illustrates a circuit diagram showing examples of a pixel and a readout circuit according to some implementations.

FIG. 20 illustrates a schematic top plan view of an example of a pixel according to some implementations.

FIG. 21 illustrates schematic cross-sectional view of the pixel of FIG. 20 according to some implementations.

FIG. 22 illustrates schematic cross-sectional view of the pixel of FIG. 20 according to some implementations.

FIG. 23 illustrates a schematic top plan view of an example of a pixel according to some implementations.

FIG. 24 illustrates a schematic top plan view of an example of a pixel according to some implementations.

FIG. 25 illustrates a schematic top plan view of an example of a pixel according to some implementations.

FIG. 26 illustrates a stack structure of an example of an image sensor according to some implementations.

FIG. 27 illustrates a stack structure of an examples of an image sensor according to some implementations.

FIG. 28 illustrates an example block diagram of an example of a computing apparatus according to some implementations.

### DETAILED DESCRIPTION

Hereinafter, example implementations will be explained in detail with reference to the accompanying drawings.

In the present disclosure, the drawings and description are to be regarded as illustrative in nature and not restrictive. Like reference numerals designate like elements throughout the specification. In a flowchart described with reference to the drawings, an order of operations may be changed, several operations may be merged, some operations may be divided, and specific operations may not be performed.

In addition, expressions written in the singular may be construed in the singular or plural unless an explicit expression such as “one” or “single” is used. Terms including ordinal numbers such as first, second, and the like will be used only to describe various component and are not to be interpreted as limiting these components. These terms may be used for the purpose of distinguishing one constituent element from other constituent elements.

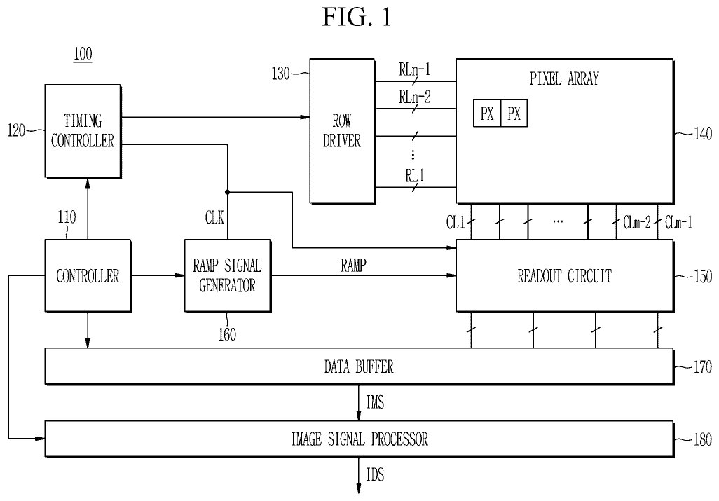

FIG. 1 illustrates a block diagram of an example of an image sensor according to some implementations. In FIG. 1, An image sensor 100 may convert light received from an outside into an electrical signal to generate an image signal IMS. The image signal IMS may be supplied to an image signal processor 180.

In some implementations, the image sensor 100 may be mounted on an electronic device having an image or light sensing function. For example, the image sensor 100 may be mounted on an electronic device such as a camera, a smartphone, a wearable device, an Internet of things (IoT) devices, a home appliance, a tablet personal computer (PC), a personal digital assistant (PDA), a portable multimedia player (PMP), a navigation device, a drone, an advanced driver assistance system (ADAS), etc. In some implementations, the image sensor 100 may be mounted on an electronic device provided as a part of a vehicle, a furniture, a manufacturing facility, a door, or various measuring devices.

Meanwhile, a frame cycle of the image sensor 100 may be defined as times required to read a reset voltage and a pixel voltage from all pixels included in a pixel array 140. In some implementations, one frame period may be equal to or greater than a product of a number of row lines RL and a horizontal period. As a frame cycle of the image sensor decreases, the image sensor 100 may generate a greater number of image data IDS during a same time. In one frame cycle, the image sensor 100 may generate one image data IDS.

In some implementations, the image sensor 100 may be operated in a global shutter mode. In the global shutter mode, the image sensor 100 may perform a shutter operation performed during a global shutter period and an effective integration time EIT, a global dumping operation performed during a global signal capture period, and a readout operation performed during a readout period. The global shutter period may be a period during which a charge accumulated in floating diffusion nodes within the pixel is reset. The integration period may be a period in which a photoelectric device is exposed to light to generate photoelectric charges. The global signal capture period may be a period that stores photoelectric charges generated during an integration period (e.g., a reset signal according to a reset level of the floating diffusion node and an image signal corresponding to photoelectric charges accumulated in a photoelectric device). In some implementations, the image sensor 100 may store photoelectric charges in at least two sampling capacitors provided internally. In some implementations, the image sensor 100 may store a corresponding value in a memory provided internally after converting the photoelectric charges from analog to digital. The readout period may be a period for reading out photoelectric charges generated in the photoelectric device. For example, the readout period may be a rolling readout period during which readout operations are sequentially performed row by row from a first row RL1 to a (n-1)^{th} row RL(n-1).

In some implementations, the image sensor 100 may perform the global shutter operation during the global signal capture period. The image sensor 100 may perform the global shutter operation to reset the charge accumulated in the floating diffusion node through a path that is different from a path that samples the photoelectric charges generated during the integration period. The image sensor 100 may include a reduced integration period, and may be capable of capturing images of fast-moving subjects or in high-light environments.

In FIG. 1, the image sensor 100 may include a controller 110, a timing generator 120, a row driver 130, a pixel array 140, a readout circuit 150, a ramp signal generator 160, a data buffer 170, and an image signal processor 180. Although the image sensor 100 is shown in FIG. 1 as including the image signal processor 180, the present disclosure is not limited thereto, and the image signal processor 180 may be positioned outside the image sensor 100.

The controller 110 may generally control each of the components 120, 130, 140, 150, 160, 170, and 180 included in the image sensor 100. The controller 110 may control operation timing of each component 120, 130, 140, 150, 160, 170, and 180 using control signals.

In some implementations, the controller 110 may control the ramp signal generator 160 to adjust a reference signal RAMP generated by the ramp signal generator 160. In some implementations, the controller 110 may control the timing controller 120 to adjust capacitance of floating diffusion (FD) of a pixel circuit in the pixel array 140 through the row driver 130. In some implementations, the controller 110 may control the timing controller 120 to adjust operation timings of elements in the pixel array 140 through the row driver 130.

The timing generator 120 may generate a signal that serves as a reference for operation timings of components of the image sensor 100. The timing generator 120 may control timings of the low driver 130, the readout circuit 150, and the ramp signal generator 160. The timing generator 120 may provide a control signal that controls the timings of the low driver 130, the readout circuit 150, and the ramp signal generator 160. In some implementations, the timing controller 120 may generate a clock signal CLK. The timing generator 120 may control timings of the low driver 130, the readout circuit 150, and the ramp signal generator 160 based on the clock signal CLK.

The timing controller 120 may control timing of elements within a pixel during the global shutter period, the integration period, the global signal capture period, and the readout period.

The pixel array 140 may include a plurality of pixels, and a plurality of row lines RL and a plurality of column lines CL respectively connected to the pixels.

In some implementations, each of the pixels may include at least one photoelectric device (also referred to as a photosensing device). The photoelectric device may detect incident light, and may convert the incident light into an electric signal according to an amount of light, i.e., a plurality of analog pixel signals. A level of an analog pixel signal outputted from the photoelectric device may be increased as an amount of charge outputted from the photoelectric device increases. That is, the level of the analog pixel signal output from the photoelectric device may be increased as an amount of light received into the pixel array 140 increases.

The row lines RL1 to RL(n-1) (RL) may extend in a first direction, and may be connected to the pixels PX positioned along the first direction. For example, the row lines RL may transmit a control signal outputted from the row driver 130 to an element, e.g., a transistor, provided in a pixel. In addition to the row lines RL, other signal lines may be arranged in the first direction. A plurality of column lines CL1 to CL(m-1) (CL) may extend in a second direction intersecting the first direction, and may be connected to a plurality of pixels PX arranged along the second direction. The column lines CL may transmit pixel signals outputted from the pixels PX to the readout circuit 150.

The row driver 130 may generate a control signal for driving the pixel array 140 in response to a control signal of the timing generator 120, and control signals may be supplied to the pixels PX of the pixel array 140 through the row lines RL. In some implementations, the row driver 130 may control the pixels PX to sense light incident in a row line unit. The row line unit may include at least one row line RL.

In response to the control signal from the timing generator 120, the readout circuit 150 may convert pixel signals (or electric signals) from the pixels PX connected to the row line RL selected from among the pixels PX into pixel values representing an amount of light. The readout circuit 150 may include a correlated double sampling circuit and an analog-digital conversion (ADC) circuit.

Meanwhile, in FIG. 1, the readout circuit 150 is illustrated as being connected to the pixel array 140 through a plurality of column lines CL, but the present disclosure is not limited thereto, and the readout circuit 150 may be included in the pixel array 140. When the readout circuit 150 is included within the pixel array 140, an analog signal within the pixel array 140 may be converted into a digital signal, and the digital signal may be directly transmitted to the data buffer 170.

The correlated double sampling (CDS) circuit may include a plurality of comparators, and each of the comparators may compare a pixel signal received from the pixel array 140 through the column lines CL with the reference signal RAMP from the ramp generator 160. Specifically, the correlated double sampling circuit 151 may compare the received pixel signal with the reference signal RAMP, and may output a comparison result thereof to an analog-to-digital conversion circuit.

A plurality of pixel signals outputted from the pixels PX may have a deviation due to a unique characteristic (e.g. fixed pattern noise (FPN), etc.) of each pixel and/or a difference in characteristics of pixel circuits (e.g., transistors for outputting charges stored in photoelectric devices within a pixel) for outputting the pixel signals from the pixels PX. In order to compensate for the deviation between the pixel signals outputted through the column lines CL, a way of obtaining a reset component (e.g., reset voltage) and a sensing component (e.g., sensing voltage) for a pixel signal and extracting a difference (e.g., a difference between the reset voltage and the sensing voltage) as a valid signal component is called correlated double sampling. The correlated double sampling circuit may output a comparison result thereof using a correlated double sampling technique for the received pixel signals.

The analog-to-digital conversion circuit may generate and output pixel values corresponding to the pixels on a row-by-row basis by converting the comparison result of the correlated double sampling circuit into digital data. The analog-to-digital conversion circuit may include a plurality of counters. A counter may be implemented as an up-counter whose count value sequentially increases based on a counting clock signal and an operation circuit, or an up/down counter, or a bit-wise inversion counter. The counters may be connected to an output of each of the comparators. Each of the counters may count a comparison result outputted from a corresponding comparator, and output digital data (e.g., a pixel value) according to a counting result.

The ramp signal generator 160 may generate the reference signal RAMP to transmit it to the readout circuit 150. The lamp signal generator 160 may include a current source, a resistor, and a capacitor. The lamp signal generator 160 may generate a plurality of ramp signals that fall or rise with a slope determined according to a current magnitude of a variable current source or a resistance value of a variable resistor by adjusting a lamp voltage, which is a voltage applied to lamp resistance, adjusting the current magnitude of the variable current source or the resistance value of the variable resistor.

The data buffer 170 may store pixel values of the pixels PX connected to a selected column line CL transmitted from the readout circuit 150. The data buffer 170 may output a pixel value stored in response to an enable signal from the controller 110 to the image signal processor 180 as an image output signal IMS.

The image signal processor 180 may perform image signal processing on the image output signal IMS received from the data buffer 170. For example, the image signal processor 180 may receive a plurality of image output signals IMS from the data buffer 170, and may generate image data IDS by synthesizing the received image output signals IMS.

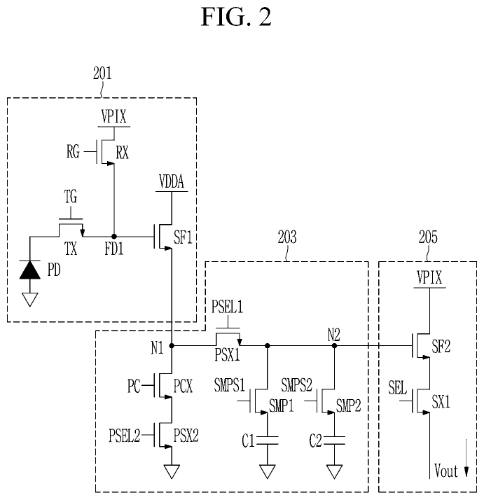

FIG. 2 illustrates a circuit diagram showing examples of a pixel and a readout circuit. In FIG. 2, a pixel may include a photoelectric charge generating circuit 201, a sampling circuit 203, and a pixel signal circuit 205. Control signals TG, RG, SEL, PSEL, SMPS1, SMPS2, SEL received from the row driver 130 may be applied to the pixel.

The photoelectric charge generating circuit 201 may transfer a photoelectric charge generated by a photoelectric device PD to the sampling circuit 203. Specifically, the photoelectric charge generating circuit 201 may include the photoelectric device PD, a transmission transistor TX, a reset transistor RX, and a first driving transistor SF1.

The photoelectric device PD may generate photoelectric charges proportional to intensity of light. For example, the photoelectric device PD may include at least one of a photo diode, a photo transistor, a photo gate, a pinned photo diode (PPD), or a combination thereof, but the present disclosure is not limited thereto.

The transmission transistor TX may be connected between the photoelectric device PD and a first floating diffusion node FD1. A first terminal of the transmission transistor TX may be connected to an output terminal of the photoelectric device PD, and a second terminal of the transmission transistor TX may be connected to the first floating diffusion node FD1. The transmission transistor TX may be controlled by a transmission control signal TG and/or a shutter control signal. When the transmission transistor TX is turned on, charges generated in the photoelectric device PD may be transferred to the first floating diffusion node FD1.

The first floating diffusion node FD1 may receive charge from the photoelectric device PD through the transmission transistor TX, and may accumulate the received charge. A parasitic capacitor may be formed at the first floating diffusion node FD1, or an actual capacitor element may be connected thereto. Depending on an amount of charges accumulated in the first floating diffusion node FD1, potential of a gate electrode of the first driving transistor SF1 may vary.

The reset transistor RX may be connected between a power supply voltage line supplying a power supply voltage VPIX and the first floating diffusion node FD1. A first terminal of the reset transistor RX may be applied with the power supply voltage VPIX, and a second terminal of the reset transistor RX may be connected to the first floating diffusion node FD1. The reset transistor RX may be controlled by a reset control signal RG. When the reset transistor RX is turned on by the reset control signal RG, a predetermined electrical potential (e.g., the power supply voltage VPIX) provided to a drain of the reset transistor RX may be transferred to the first floating diffusion node FD1. Accordingly, when the reset transistor RX is turned on, photoelectric charges accumulated in the first floating diffusion node FD1 may be discharged, so the first floating diffusion node FD1 may be set to the power supply voltage VPIX.

A gate of the first driving transistor SF1 may be connected to the first floating diffusion node FD1. The first driving transistor SF1 may buffer a signal according to an amount of charges charged in the first floating diffusion node FD1 as a source follower buffer amplifier. The power supply voltage VPIX may be applied to a first terminal of the first driving transistor SF1, and a second terminal of the first driving transistor SF1 may be connected to a first output node N1. A potential of the first floating diffusion node FD1 changes according to the amount of charges accumulated in the first floating diffusion node FD1, and as the potential of the first floating diffusion node FD1 changes, the first driving transistor SF1 may amplify the potential change at the first floating diffusion node FD1 and output an amplified result to the first output node N1.

The sampling circuit 203 may include a precharge transistor PCX, a first precharge transistor PSX1, a second precharge selection transistor PSX2, a first sampling transistor SMP1, a second sampling transistor SMP2, a first capacitor C1, and a second capacitor C2.

The precharge transistor PCX may be connected between the first output node N1 and the second precharge selection transistor PSX2. A first terminal of the precharge transistor PCX may be connected to the first output node N1, and a second terminal may be connected to the second precharge select transistor PSX2. The precharge transistor PCX may be controlled by a precharge control signal PC. The precharge transistor PCX may precharge the first output node N1 according to the precharge control signal PC. In some implementations, the precharge transistor PCX may precharge a predetermined voltage to the first output node N1 based on the precharge control signal PC.

The first precharge transistor PSX1 may be connected between the first output node N1 and a second output node N2. The first precharge selection transistor PSX1 may be controlled by a first precharge selection control signal PSEL1. The second output node N2 may have parasitic capacitance.

The second precharge selection transistor PSX2 may be connected between the precharge transistor PCX and a ground voltage. A first terminal of the second precharge selection transistor PSX2 may be connected to the first output node N1, and the ground voltage may be applied to a second terminal of the second precharge selection transistor PSX2. The second precharge selection transistor PSX2 may be controlled by a second precharge selection control signal PSEL2. The second precharge selection transistor PSX2 may reset the first output node N1 according to the second precharge selection control signal PSEL2. That is, the first driving transistor SF1, the precharge transistor PCX, and the second precharge selection transistor PSX2 may be connected in series.

The first sampling transistor SMP1 may be connected between the second output node N2 and a first capacitor C1. A first terminal of the first sampling transistor SMP1 may be connected to the second output node N2, and a second terminal of the first sampling transistor SMP1 may be connected to the first capacitor C1. The first sampling transistor SMP1 may be controlled by the first sampling control signal SMPS1. When the first sampling transistor SMP1 is turned on, the first capacitor C1 and the second output node N2 may be connected, and an electrical signal of the second output node N2 may be sampled.

The ground voltage may be applied to a first terminal of the first capacitor C1, and a second terminal of the first capacitor C1 may be connected to the first sampling transistor SMP1. Charges may be accumulated in the first capacitor C1 according to a switching operation of the first sampling transistor SMP1. The first capacitor C1 may accumulate charges corresponding to a signal buffered according to an amount of charges charged to the first floating diffusion node FD1. For example, the first capacitor C1 may accumulate charges corresponding to a signal buffered based on a charge amount of the first floating diffusion FD1 that is reset during the global shutter period.

The second sampling transistor SMP2 may be connected to the second output node N2 and the first capacitor C2. A first terminal of the second sampling transistor SMP2 may be connected to the second output node N2, and a second terminal of the second sampling transistor SMP2 may be connected to the first capacitor C2. The second sampling transistor SMP2 may be controlled by the second sampling control signal SMPS2. When the second sampling transistor SMP2 is turned on, the second capacitor C2 and the second output node N2 may be connected, and an electrical signal of the second output node N2 may be sampled.

The ground voltage may be applied to a first terminal of the second capacitor C2, and a second terminal of the second capacitor C2 may be connected to the second sampling transistor SMP2. Charges may be accumulated in the second capacitor C2 according to a switching operation of the second sampling transistor SMP2. The second capacitor C2 may accumulate charges corresponding to a signal buffered according to an amount of charges charged to the first floating diffusion node FD1. For example, the second capacitor C2 may accumulate charges corresponding to a signal buffered based on a charge amount of the first floating diffusion FD1 that is reset during the integration period.

The pixel signal circuit 205 may include a second driving transistor SF2 and a selection transistor SX1.

A gate of the second driving transistor SF2 may be connected to the second output node N2. The second driving transistor SF2 may buffer a signal according to an amount of charges charged to the second output node N2 as a source follower buffer amplifier. The power supply voltage VPIX may be applied to a first terminal of the second driving transistor SF2, and a second terminal of the second driving transistor SF2 may be connected to the first terminal of the selection transistor SX1. The second driving transistor SF2 may amplify a potential change at the second output node N2 to output it to the first terminal of the selection transistor SX1.

The first terminal of the selection transistor SX1 may be connected to the second driving transistor SF2, and the second terminal of the selection transistor SX1 may be connected to the column line CL. The selection transistor SX1 may be controlled by a selection control signal SEL. The row driver 130 (in FIG. 1) may select a unit pixel to be read row by row through the selection control signal SEL. When the selection transistor SX1 is turned on, the pixel signal Vout may be output to the column line CL. The column line CL may be one of the first to m^{th} column lines CL1 to CL(m-1) of FIG. 1. The pixel signal Vout may include a reset signal corresponding to a reset operation, an image signal corresponding to a charge accumulation operation, etc.

That is, the second driving transistor SF2 and the selection transistor SX1 may output the pixel signal Vout according to a potential change at the second output node N2 to the column line CL. The pixel signal Vout may be based on a potential at the second output node N2 corresponding to one of the amount of charges stored in the first capacitor C1 and the amount of charges stored in the second capacitor C2.

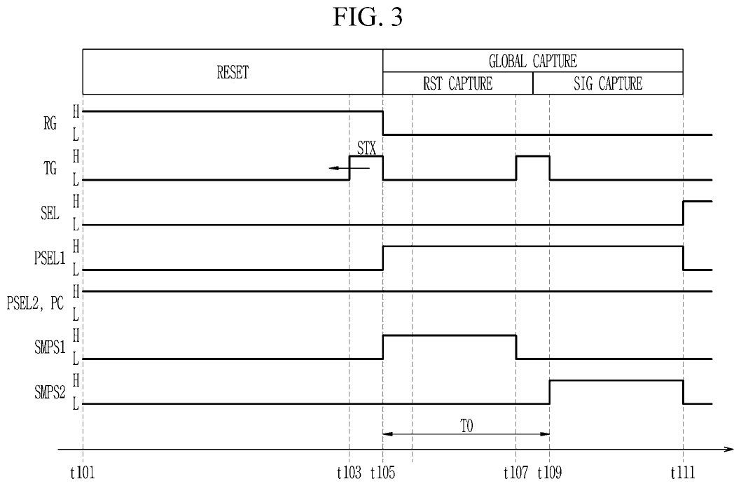

FIG. 3 illustrates a timing diagram showing an example of an operation of an image sensor including the pixel according to FIG. 2 according to some implementations. FIG. 3 illustrates a timing diagram showing the global shutter period (GLOBAL SHUTTER) t101 to t105 and the global capture period (GLOBAL CAPTURE) t105 to t111 of the image sensor.

During the global shutter period t101 to t105, the charges stored in the photoelectric device PD and the first floating diffusion node FD1 may be reset.

First, at t101, the reset control signal RG, the second precharge selection control signal PSEL2, and the precharge control signal PC may have a high level H. The transmission control signal TG, the selection signal SEL, the first precharge selection control signal PSEL1, the first sampling control signal SMPS1, the second sampling control signal SMPS2 may have a low level L.

During the period t101 to t105, the transmission control signal TG may transition to an arbitrary pulse shape STX. A pulse shape may be a shape in which a signal of the low level L may transition to the high level H, and then may transition from the high level H back to the low level L after a certain period of time. When the transmission control signal TG of the high level His applied to a gate of the transmission transistor TX, the transmission transistor TX may be turned on. Accordingly, the power supply voltage VPIX may be supplied to the floating node FD1 and the photoelectric device PD.

In FIG. 2, the transmission control signal TG is illustrated as transitioning from the low level L to the high level H at t103, but the present disclosure is not limited thereto, and the transmission control signal TG may transition from the low level L to the high level H at any time point between t101 and t103.

The global capture period (GLOBAL CAPTURE) t105 to t111 may be a period for sampling the charges accumulated in the first floating diffusion node FD1.

At t105, the reset control signal RG and the transmission control signal TG may transition from the high level H to the low level L. In addition, the first precharge selection control signal PSEL1 and the first sampling control signal SMPS1 may transition from the low level L to the high level H.

Meanwhile, the first floating diffusion node FD1 may be reset to the power supply voltage VPIX. The first driving transistor SF1 may buffer a reset voltage corresponding to the power supply voltage VPIX of the first floating diffusion node FD1 to the first output node N1. The first precharge selection transistor PSX1 may be turned on by the first precharge selection control signal PSEL1 of the high level H. Accordingly, the reset voltage buffered in the first output node N1 may be transferred to the second output node N2.

The first sampling transistor SMP1 may be turned on by the first sampling control signal SMPS1 of the high level H. Accordingly, the first capacitor C1 may sample a signal of the second output node N2. That is, the first capacitor C1 may sample the reset voltage.

When sampling the reset voltage, the reset voltage stored in the first floating diffusion node FD1 may be stored in the first capacitor C1 through the first driving transistor SF1, the first precharge transistor PSX1, and the first sampling transistor SMP1. When a shutter operation in which the transmission control signal TG transitions in a pulse form is performed during a period in which the reset voltage is sampled, a voltage of the first floating diffusion node FD1 may be affected. Accordingly, the reset voltage may not be sampled accurately, and to avoid this, a pulse STX for a shutter operation may have to be performed before t105 when the first sampling control signal SMPS1 starts sampling the reset voltage.

Meanwhile, the integration period may be from a time when the pulse STX transitions to the low level L to a time when the transmission control signal TG transitions to the low level L. Accordingly, a shortest integration period that the image sensor can have may be a first period T0. During the first period T0, depending on intensity of light incident on the image sensor, photoelectric charges may be generated in the photoelectric device PD, and the generated photoelectric charges may be accumulated in the first floating diffusion node FD1.

A time for sampling the reset voltage may be determined by a capacity of the first capacitor C1 and a magnitude of a current flowing to the image sensor. That is, the time for sampling the reset voltage may be extended, so a time point at which an image voltage is sampled may be a long time after the shutter operation is performed.

At t107, the transmission control signal TG may transition from the low level L to the high level H. The first sampling control signal SMPS1 may transition from the high level H to the low level L.

The transmission transistor TX may be turned on by the transmission control signal TG of the high level H. Accordingly, the photoelectric charges generated in the photoelectric device PD during an integration period T0 from t105 to t107 may be transferred to the first floating diffusion node FD1. The first driving transistor SF1 may buffer an image voltage accumulated in the first floating diffusion FD1 to the first output node N1. Herein, the image voltage may be a voltage generated in the first floating diffusion FD1 by the photoelectric charges generated during the integration period T0.

The first precharge transistor PSX1 may be turned on by the first precharge selection control signal PSEL1 of the high level H. Accordingly, the image voltage buffered at the first output node N1 by the first driving transistor SF1 may be transferred to the second output node N2.

At t109, the transmission control signal TG may transition from the high level H to the low level L. The second sampling control signal SMPS2 may transition from the low level L to the high level H.

The second sampling transistor SMP2 may be turned on by the second sampling control signal SMPS2 of the high level H. Accordingly, the second capacitor C2 may sample a signal of the second output node N2. That is, the second capacitor C2 may sample the image voltage.

At t111, the second precharge selection control signal PSEL1 and the second sampling control signal SMPS2 may transition from the high level H to the low level L.

Thereafter, the image sensor may read out a pixel signal corresponding to the photoelectric charges generated in the pixel. In some implementations, the image sensor may read out values stored in the first capacitor C1 and the second capacitor C2.

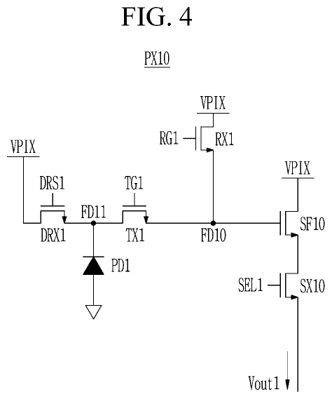

FIG. 4 illustrates a circuit diagram showing an example of a pixel according to some implementations. In FIG. 4, the pixel PX10 may include a photoelectric device D1, a drain transistor DRX1, a transmission transistor TX1, a reset transistor RX1, a first driving transistor SF10, and a first selection transistor SX10.

The photoelectric device PD1 may generate photoelectric charges proportional to intensity of light. The photoelectric device PD1 may be connected to the second floating diffusion node FD11.

The second floating diffusion node FD11 may receive charge from the photoelectric device PD1, and may accumulate the received charge. A parasitic capacitor may be formed at the second floating diffusion node FD11, or an actual capacitor element may be connected thereto.

The second transmission transistor TX1 may be connected between the photoelectric device PD1 and the first floating diffusion node FD10. A first terminal of the transmission transistor TX1 may be connected to an output terminal of the photoelectric device PD1, and a second terminal of the transmission transistor TX1 may be connected to the first floating diffusion node FD10. The transmission transistor TX1 may be controlled by a transmission control signal TG1 and/or a shutter control signal. When the transmission transistor TX1 is turned on, the charges generated in the photoelectric device PD1 may be transmitted to the first floating diffusion node FD10.

The drain transistor DRX1 may be connected between the second floating diffusion node FD11 and a power supply voltage VPIX. A first terminal of the drain transistor DRX1 may be connected to an output terminal of the photoelectric device PD1, and a second terminal of the drain transistor DRX1 may be connected to the power supply voltage VPIX. The drain transistor DRX1 may be controlled by a drain control signal DRS1. When the drain transistor DRX1 is turned on, the second floating diffusion node FD11 may be set to the power supply voltage VPIX.

The first floating diffusion node FD10 may receive charge from the photoelectric device PD1 through the transmission transistor TX1, and may accumulate the received charge. A parasitic capacitor may be formed at the first floating diffusion node FD10, or an actual capacitor element may be connected thereto. Depending on an amount of charges accumulated in the first floating diffusion node FD10, potential of a gate electrode of the first driving transistor SF10 may vary.

The reset transistor RX1 may be connected between a power supply voltage line supplying the power supply voltage VPIX and the first floating diffusion node FD10. A first terminal of the reset transistor RX1 may be applied with the power supply voltage VPIX, and a second terminal of the reset transistor RX1 may be connected to the first floating diffusion node FD10. The reset transistor RX1 may be controlled by the reset control signal RG1. When the reset transistor RX1 is turned on by the reset control signal RG1, a predetermined electrical potential (e.g., the power supply voltage VPIX) provided to a drain of the reset transistor RX1 may be transferred to the first floating diffusion node FD10. Accordingly, when the reset transistor RX1 is turned on, photoelectric charges accumulated in the first floating diffusion node FD10 may be discharged, so the first floating diffusion node FD10 may be set to the power supply voltage VPIX.

A gate of the first driving transistor SF10 may be connected to the first floating diffusion node FD10. The first driving transistor SF10 may buffer a signal according to an amount of charges charged to the first floating diffusion node FD10 as a source follower buffer amplifier. The power supply voltage VPIX may be applied to a first terminal of the first driving transistor SF10, and a second terminal of the first driving transistor SF10 may be connected to a selection transistor SX10. A potential of the first floating diffusion node FD10 changes according to the amount of charges accumulated in the first floating diffusion node FD10, and as the potential of the first floating diffusion node FD10 changes, the first driving transistor SF10 may amplify the potential change at the first floating diffusion node FD10 and output an amplified result to a first terminal of the first selection transistor SX10.

A first terminal of the selection transistor SX10 may be connected to the first driving transistor SF10, and a second terminal of the selection transistor SX10 may be connected to the column line CL. The selection transistor SX10 may be controlled by a selection control signal SEL. The row driver 130 (in FIG. 1) may select a unit pixel to be read row by row through the selection control signal SEL. When the selection transistor SX10 is turned on, the pixel signal Vout1 may be output to the column line CL. The column line CL may be one of the first to m^{th} column lines CL1 to CL(m-1) of FIG. 1. The pixel signal Vout may include a reset signal corresponding to a reset operation, an image signal corresponding to a charge accumulation operation, etc.

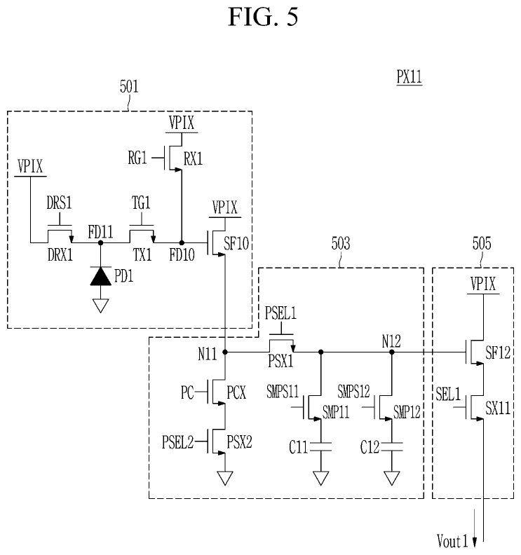

FIG. 5 illustrates a circuit diagram showing an example of a pixel according to some implementations. In FIG. 5, the pixel PX11 may include a photoelectric charge generating circuit 501, a sampling circuit 503, and a pixel signal generating circuit 505.

The photoelectric charge generating circuit 501 may transfer a photoelectric charge generated by a photoelectric device PD1 to the sampling circuit 503. Specifically, the photoelectric charge generating circuit 501 may include the photoelectric device PD1, a transmission transistor TX, a reset transistor RX, and a first driving transistor SF10. Unless otherwise stated, the description of the pixel PX10 of FIG. 4 may be equally applied to the photoelectric charge generating circuit 501.

The sampling circuit 503 may include a precharge transistor PCX, a first precharge transistor PSX1, a second precharge selection transistor PSX2, a first sampling transistor SMP11, a second sampling transistor SMP12, a first capacitor C11, and a second capacitor C12.

The precharge transistor PCX may be connected between the first output node N11 and the second precharge selection transistor PSX2. A first terminal of the precharge transistor PCX may be connected to the first output node N11, and a second terminal may be connected to the second precharge select transistor PSX2. The precharge transistor PCX may be controlled by a precharge control signal PC. The precharge transistor PCX may precharge the first output node N11 according to the precharge control signal PC. In some implementations, the precharge transistor PCX may precharge a predetermined voltage to the first output node N11 based on the precharge control signal PC.

The first precharge transistor PSX1 may be connected between the first output node N11 and a second output node N12. The first precharge selection transistor PSX1 may be controlled by a first precharge selection control signal PSEL1. The second output node N12 may have parasitic capacitance.

The second precharge selection transistor PSX2 may be connected between the precharge transistor PCX and a ground voltage. A first terminal of the second precharge selection transistor PSX2 may be connected to the first output node N11, and the ground voltage may be applied to a second terminal of the second precharge selection transistor PSX2. The second precharge selection transistor PSX2 may be controlled by a second precharge selection control signal PSEL2. The second precharge selection transistor PSX2 may reset the first output node N11 according to the second precharge selection control signal PSEL2. That is, the first driving transistor SF10, the precharge transistor PCX, and the second precharge selection transistor PSX2 may be connected in series.

The first sampling transistor SMP11 may be connected between the second output node N12 and a first capacitor C11. A first terminal of the first sampling transistor SMP11 may be connected to the second output node N12, and a second terminal of the first sampling transistor SMP11 may be connected to the first capacitor C11. The first sampling transistor SMP11 may be controlled by the first sampling control signal SMPS11. When the first sampling transistor SMP11 is turned on, the first capacitor C11 and the second output node N12 may be connected, and an electrical signal of the second output node N12 may be sampled.

The ground voltage may be applied to a first terminal of the first capacitor C11, and a second terminal of the first capacitor C11 may be connected to the first sampling transistor SMP11. Charges may be accumulated in the first capacitor C11 according to a switching operation of the first sampling transistor SMP11. The first capacitor C11 may accumulate charges corresponding to a signal buffered according to an amount of charges charged to the first floating diffusion node FD10. For example, the first capacitor C11 may accumulate charges corresponding to a signal buffered based on a charge amount of the first floating diffusion FD10 that is reset during the global shutter period.

The second sampling transistor SMP12 may be connected to the second output node N12 and the first capacitor C12. A first terminal of the second sampling transistor SMP12 may be connected to the second output node N12, and a second terminal of the second sampling transistor SMP12 may be connected to the first capacitor C12. The second sampling transistor SMP12 may be controlled by the second sampling control signal SMPS2. When the second sampling transistor SMP12 is turned on, the second capacitor C12 and the second output node N12 may be connected, and an electrical signal of the second output node N12 may be sampled.

The ground voltage may be applied to a first terminal of the second capacitor C12, and a second terminal of the second capacitor C12 may be connected to the second sampling transistor SMP12. Charges may be accumulated in the second capacitor C12 according to a switching operation of the second sampling transistor SMP12. The second capacitor C12 may accumulate charges corresponding to a signal buffered according to an amount of charges charged to the first floating diffusion node FD10. For example, the second capacitor C12 may accumulate charges corresponding to a signal buffered based on a charge amount of the first floating diffusion FD10 that is reset during the integration period.

Meanwhile, in FIG. 5, the image sensor 100 is illustrated as including two sampling transistors, but the present disclosure is not limited thereto, and the image sensor 100 may include a plurality of sampling transistors.

The pixel signal circuit 505 may include a second driving transistor SF12 and a selection transistor SX11.

A gate of the second driving transistor SF12 may be connected to the second output node N12. The second driving transistor SF12 may buffer a signal according to an amount of charges charged to the second output node N12 as a source follower buffer amplifier. The power supply voltage VPIX may be applied to a first terminal of the second driving transistor SF12, and a second terminal of the second driving transistor SF12 may be connected to the first terminal of the selection transistor SX11. The second driving transistor SF12 may amplify a potential change at the second output node N12 to output it to the first terminal of the selection transistor SX11.

The first terminal of the selection transistor SX11 may be connected to the second driving transistor SF12, and the second terminal of the selection transistor SX11 may be connected to the column line CL. The selection transistor SX11 may be controlled by a selection control signal SEL. The row driver 130 (in FIG. 1) may select a unit pixel to be read row by row through the selection control signal SEL. When the selection transistor SX11 is turned on, the pixel signal Vout1 may be output to the column line CL. The column line CL may be one of the first to m^{th} column lines CL1 to CL(m-1) of FIG. 1. The pixel signal Vout1 may include a reset signal corresponding to a reset operation, an image signal corresponding to a charge accumulation operation, etc.

That is, the second driving transistor SF12 and the selection transistor SX11 may output the pixel signal Vout1 according to a potential change at the second output node N12 to the column line CL. The pixel signal Vout1 may be based on a potential at the second output node N12 corresponding to one of the amount of charges stored in the first capacitor C11 and the amount of charges stored in the second capacitor C12.

The readout circuit 150 (in FIG. 1) may sequentially read out data of all pixels captured throughout the pixel array 140. The readout circuit 150 may convert the received pixel signal Vout1 into a digital signal through an analog-to-digital converter ADC, and may transmit it to the data buffer 170.

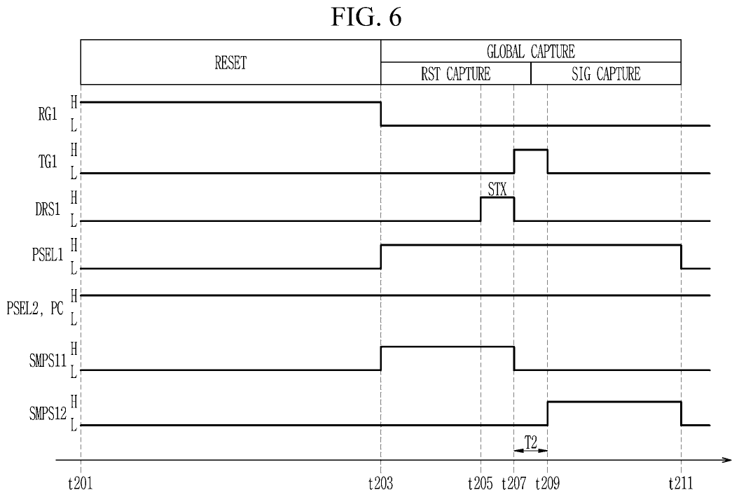

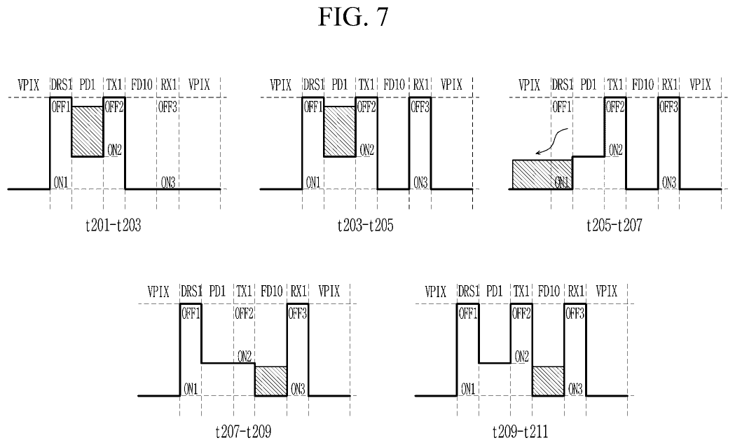

FIG. 6 illustrates a timing diagram showing an example of an operation of the pixel according to FIG. 5 according to some implementations. FIG. 7 illustrates examples of changes in potential level of each channel region within the change in potential level of each channel pixel according to FIG. 5 according to some implementations.

FIG. 6 illustrates a timing diagram showing the global shutter period (GLOBAL SHUTTER) t201 to t203 and the global capture period (GLOBAL CAPTURE) t203 to t211 of the image sensor. An operation of the image sensor 100 during the global shutter period (GLOBAL SHUTTER) and the global capture period (GLOBAL CAPTURE) will be described together with reference to FIG. 7. In FIG. 7, along a vertical direction, a potential of each channel increases as a size of D1 increases and decreases as the size of D1 decreases. Additionally, capacitance of each channel is represented by a width along a direction D2.

During the global shutter period t201 to t203, the charges stored in the photoelectric device PD1 and the first floating diffusion node FD10 may be reset.

First, at t201 to t203, the reset control signal RG1, the second precharge selection control signal PSEL2, and the precharge control signal PC may have a high level H. The transmission control signal TG1, the drain control signal DRS1, the first precharge selection control signal PSEL1, a first sampling control signal SMPS11, a second sampling control signal SMPS12 may have the low level L.

In FIG. 7 together, a potential level of each of the power supply voltage VPIX, a channel region of the drain transistor DRX1, a region of the photoelectric device PD1, a channel region of the transmission transistor TX1, a region of the floating node FD10, a channel region of the reset transistor RX1, and the power supply voltage VPIX are illustrated.

An amount of photoelectric charges generated from the photoelectric device PD1 may correspond to an area of the hatched portion in a region of the photoelectric device PD1 in FIG. 7. A potential level of a channel region of the drain transistor DRX1 may vary between the first potential ON1 and the second potential OFF1 in response to a logic level of the drain control signal DRS1. A potential level of a channel region of the transmission transistor TX1 may vary between a first potential ON2 and a second potential OFF2 in response to a logic level of the transmission signal TG1. A potential level of a channel region of the reset transistor RX1 may vary between a first potential ON3 and a second potential OFF3 in response to a logic level of the reset signal RG1. Furthermore, the power supply voltage VPIX may have a potential A. In FIG. 4, the second potential OFF1 and the second potential OFF2 are depicted as a same potential, but the present disclosure is not limited thereto, and the second potential OFF1 and the fourth potential OFF2 may be different.

At t201 to t203, the reset transistor RX1 is turned on and thus may have the first potential ON3. The drain transistor DRX1 is turned off and thus may have the second potential OFF1, and the transmission transistor TX1 is turned off and thus may have the second potential OFF2. Accordingly, the photoelectric charges accumulated in the photoelectric device PD1 may not be transferred to the floating node FD10.

The global capture period (GLOBAL CAPTURE) t203 to t211 may be a period for sampling the charges accumulated in the first floating diffusion node FD10.

At t203, the reset control signal RG1 may transition from the high level H to the low level L. In addition, the first precharge selection control signal PSEL1 and the first sampling control signal SMPS11 may transition from the low level L to the high level H.

Meanwhile, the first floating diffusion node FD10 may be reset to the power supply voltage VPIX. The first driving transistor SF1 may buffer a reset voltage corresponding to the power supply voltage VPIX of the first floating diffusion node FD10 to the first output node N11. The first precharge selection transistor PSX1 may be turned on by the first precharge selection control signal PSEL1 of the high level H. Accordingly, the reset voltage buffered in the first output node N11 may be transferred to the second output node N12.

The first sampling transistor SMP1 may be turned on by the first sampling control signal SMPS11 of the high level H. Accordingly, the first capacitor C11 may sample a signal of the second output node N12. That is, the first capacitor C11 may sample the reset voltage.

In some implementations, during the period t201 to t207, the drain control signal DRS1 may transition to an arbitrary pulse shape STX. A pulse shape may be a shape in which a signal of the low level L may transition to the high level H, and then may transition from the high level H back to the low level L after a certain period of time. When the drain control signal DRS1 of the high level H is applied to a gate of the drain transistor DRX1, the drain transistor DRX1 may be turned on. Accordingly, the power supply voltage VPIX may be supplied to the floating node FD10 and the photoelectric device PD1.

In FIG. 7, since the reset transistor RX1 is turned off during the period t203 to t205, the reset transistor RX1 may have the second potential OFF3.

In FIG. 6, the drain control signal DRS1 is illustrated as transitioning from the low level L to the high level H at t205, but the present disclosure is not limited thereto, and the drain control signal DRS1 may transition in the arbitrary pulse shape STX at any time point from t201 to t207.

At t205 to t207, the drain transistor DRX1 is turned on, so the drain transistor DRX1 may have the first potential ON1. Accordingly, the photoelectric charges generated in the photoelectric device PD1 may be reset to the power supply voltage VPIX through the drain transistor DRX1 without affecting the charge stored in the first floating diffusion node FD10. Accordingly, the first floating diffusion node FD10 may store a charge corresponding to the reset voltage in response to the power supply voltage VPIX.

When sampling the reset voltage, the reset voltage stored in the first floating diffusion node FD10 may be stored in the first capacitor C11 through the first driving transistor SF1, the first precharge transistor PSX1, and the first sampling transistor SMP1. Even if a shutter operation in which the drain control signal DRS1 transitions in a pulse form is performed during a period in which the reset voltage is sampled, a voltage of the first floating diffusion node FD10 may not be affected because the transmission transistor TX1 is turned off. Accordingly, the pulse STX for the shutter operation may be performed even while the first sampling control signal SMPS11 is sampling a reset voltage.

Meanwhile, the integration period may be from a time when the pulse STX transitions to the low level L to a time when the transmission control signal TG1 transitions to the low level L. Accordingly, a shortest integration period that the image sensor can have may be a first period T2. During the first period T2, depending on intensity of light incident on the image sensor, photoelectric charges may be generated in the photoelectric device PD, and the generated photoelectric charges may be accumulated in the first floating diffusion node FD10.

That is, the image sensor 100 may reset the photoelectric charges generated by the photoelectric device PD1 through the drain transistor DRX1, and thus perform the shutter operation within a reset capture period (RST CAPTURE). Accordingly, a first period T2, which is a minimum integration period, may be reduced to, e.g., 1 μs or less. Therefore, the image sensor 100 may maximize sensor performance even during high-speed shooting.

At t207, the transmission control signal TG1 may transition from the low level L to the high level H. The first sampling control signal SMPS11 may transition from the high level H to the low level L.

The transmission transistor TX may be turned on by the transmission control signal TG1 of the high level H. Accordingly, the photoelectric charges generated in the photoelectric device PD1 during an integration period T2 from t207 to t209 may be transferred to the first floating diffusion node FD10. The first driving transistor SF1 may buffer an image voltage accumulated in the first floating diffusion FD10 to the first output node N11. Herein, the image voltage may be a voltage generated in the first floating diffusion FD10 by the photoelectric charges generated during the integration period T0.

The first precharge transistor PSX1 may be turned on by the first precharge selection control signal PSEL1 of the high level H. Accordingly, the image voltage buffered at the first output node N11 by the first driving transistor SF1 may be transferred to the second output node N12.

At t207 to t209, the drain transistor DRX1 is turned off, so the drain transistor DRX1 may have the second potential OFF1. The transmission transistor TX1 is turned on, so the transmission transistor TX1 may have the first potential ON2. The reset transistor RX1 is turned off, so the reset transistor RX1 may have the second potential OFF3. Accordingly, the photoelectric charges generated in the photoelectric device PD1 may be transferred to the first floating diffusion node FD10 through the transmission transistor TX1.

At t209, the transmission control signal TG1 may transition from the high level H to the low level L. The second sampling control signal SMPS12 may transition from the low level L to the high level H.

The second sampling transistor SMP2 may be turned on by the second sampling control signal SMPS12 of the high level H. Accordingly, the second capacitor C2 may sample a signal of the second output node N12. That is, the second capacitor C2 may sample the image voltage.

At t209 to t211, the drain transistor DRX1 is turned off, so the drain transistor DRX1 may have the second potential OFF1. The transmission transistor TX1 is turned off, so the transmission transistor TX1 may have the second potential OFF2. The reset transistor RX1 is turned off, so the reset transistor RX1 may have the second potential OFF3. Accordingly, charges corresponding to the image voltage may be stored in the first floating diffusion node FD10.

At t211, the second precharge selection control signal PSEL1 and the second sampling control signal SMPS12 may transition from the high level H to the low level L.

Thereafter, the image sensor may read out a pixel signal corresponding to the photoelectric charges generated in the pixel. In some implementations, the image sensor may read out values stored in the first capacitor C11 and the second capacitor C2.

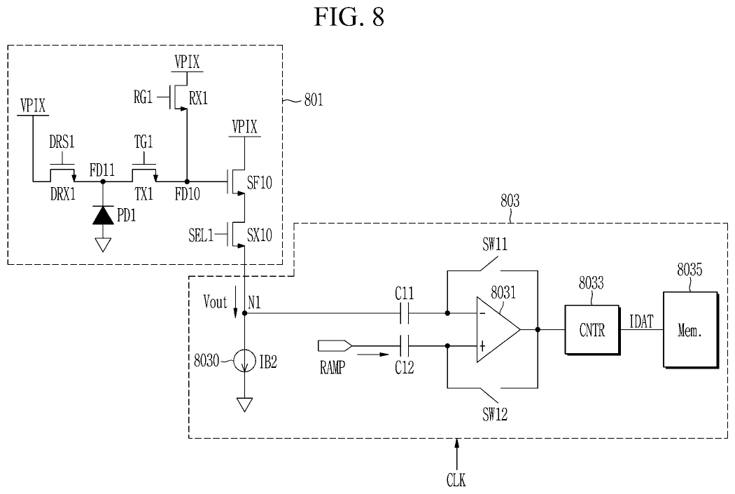

FIG. 8 illustrates a circuit diagram showing examples of a pixel and a readout circuit according to some implementations. In FIG. 8, an image sensor 100 may include a photoelectric charge generating circuit 801 and a readout circuit 803. The readout circuit 803 may convert the pixel signal Vout generated by the photoelectric charge generating circuit 801 into a pixel value. A pixel value may be image data having multiple bits.

The photoelectric charge generating circuit 801 may output a photoelectric charge generated by the photoelectric device PD1 to a first node N1. Specifically, the photoelectric charge generating circuit 801 may include the photoelectric device PD1, a transmission transistor TX, a reset transistor RX, and a first driving transistor SF10. Unless otherwise stated, the description of the pixel PX10 of FIG. 4 may be equally applied to the photoelectric charge generating circuit 801.

The readout circuit 803 may be connected to the first node N1. The readout circuit 803 may include a first current source 8030, a comparator 8031, a counter circuit 8033, and a memory 8035.

The first current source 8030 may be connected between the first node N1 and a ground power source. The first current source 8030 may supply a first current IB2 preset to the first node N1 such that a constant current flows through the first node N1.

A first input terminal of the comparator 8031 may be connected to the column line CL through a first capacitor C11, and a second input terminal may be connected to a ramp signal generator 160 through a second capacitor C12. The comparator 8031 may compare the pixel signal Vout and a reference signal RAMP to output a comparison result thereof to a corresponding counter (8033) through a first output terminal.

A first switch SW11 may be connected between a first input terminal and a first output terminal of the comparator 8031. A second switch SW12 may be connected between the second input terminal and the first output terminal of the comparator 8031. The first switch SW11 and the second switch SW12 may be turned on or off based on the clock signal CLK. As the first switch SW1 and/or the second switch SW12 connect the input terminal and the output terminal of the comparator 8031, the comparator 8031 may stably output a comparison result thereof.

The counter 8033 may be connected to the output terminal of the corresponding comparator 8031. The counter 8033 may include an up/down counter or a bit-wise counter.

In some implementations, the counter 8033 may receive the clock signal CLK from the timing controller 120. For example, the counter 8033 may count how long a specific level of a signal output from the comparator 8031 is maintained using a rising edge or falling edge of the clock signal CLK. For example, the counter 8033 may count a time when a high level corresponding to a logic level “1” is output from the comparator 8031. The counter 8033 may count a comparison result thereof to generate image data IDAT. The counter 8033 may transfer image data IDAT to the memory 8035.

The memory 8035 may store the image data IDAT. In some implementations, the memory 8035 may store the image data IDAT on a frame-by-frame basis. The memory may be referred to as a graphics random access memory (RAM), a frame buffer, etc. The memory may include a volatile memory, such as a dynamic random access memory (DRAM) or a static random access memory (SRAM), or a nonvolatile memory, such as a ROM, a flash memory, a resistive random access memory (ReRAM), or a magnetic random access memory (MRAM).

Thereafter, the controller 110 (in FIG. 1) may control the readout circuit 150 to read out pixel values captured across the entire pixel array 140, converted into digital signals, and stored as the image data IDAT. The readout circuit 150 may read out data stored in the memory 8035 to transfer it to the data buffer 170.

Meanwhile, in FIG. 8, the readout circuit 150 is illustrated as including the memory 8035, but the present disclosure is not limited thereto, and the memory 8035 may be included in another configuration within the image sensor 100.

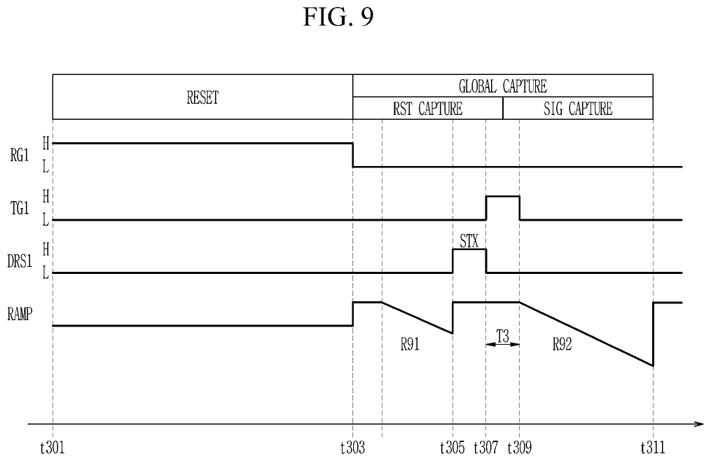

FIG. 9 illustrates a timing diagram showing an example of an operation of an image sensor according to FIG. 8 according to some implementations. In, FIG. 9 a timing diagram shows the global shutter period (GLOBAL SHUTTER) t301 to t305 and the global capture period (GLOBAL CAPTURE) t305 to t311 of the image sensor.

During the global shutter period t301 to t305, the charges stored in the photoelectric device PD1 and the first floating diffusion node FD10 may be reset.

First, at t301 to t303, the reset control signal RG1 may have the high level H. The transmission control signal TG1 and the drain control signal DRS1 may have the low level L.

Accordingly, the photoelectric charges accumulated in the photoelectric device PD1 may not be transferred to the floating node FD10.

The global capture period (GLOBAL CAPTURE) t303 to t311 may be a period for sampling the charges accumulated in the first floating diffusion node FD10.

At t303, the reset control signal RG1 may transition from the high level H to the low level L.

In some implementations, during the period t301 to t307, the drain control signal DRS1 may transition to an arbitrary pulse shape STX.

During the period t301 to t305, a first ramp signal R91 may be provided to the comparator 8031 in synchronization with a target signal to be compared. The comparator 8031 may output a result of comparing the pixel signal corresponding to the reset voltage, which is the target signal to be compared, with the first ramp signal R91 based on the clock signal CLK.

The counter 8033 may count a comparison result thereof received from the comparator 8031 to generate the image data IDAT corresponding to the reset voltage.

In FIG. 9, the drain signal DRS1 is illustrated as transitioning from the low level L to the high level H at t305, but the present disclosure is not limited thereto, and the drain control signal DRS1 may transition from the low level L to the high level H at any time point between t301 and t307.

When sampling the reset voltage, the reset voltage stored in the first floating diffusion node FD10 may be stored in the first capacitor C11 through the first driving transistor SF1, the first precharge transistor PSX1, and the first sampling transistor SMP1. Even if a shutter operation in which the drain control signal DRS1 transitions in a pulse form is performed during a period in which the reset voltage is sampled, a voltage of the first floating diffusion node FD10 may not be affected because the transmission transistor TX1 is turned off. Accordingly, the pulse STX for the shutter operation may be performed even while the first sampling control signal SMPS11 is sampling a reset voltage.

Meanwhile, the integration period may be from a time when the pulse STX transitions to the low level L to a time when the transmission control signal TG1 transitions to the low level L. Accordingly, a shortest integration period that the image sensor can have may be a first period T3. During the first period T3, depending on intensity of light incident on the image sensor, photoelectric charges may be generated in the photoelectric device PD, and the generated photoelectric charges may be accumulated in the first floating diffusion node FD10.

That is, the image sensor 100 may reset the photoelectric charges generated by the photoelectric device PD1 through the drain transistor DRX1, and thus perform the shutter operation within a reset capture period (RST CAPTURE). Accordingly, a first period T3, which is a minimum integration period, may be reduced to, e.g., 1 μs or less. Accordingly, the image sensor 100 may maximize sensor performance even during high-speed shooting.

At t307, the transmission control signal TG1 may transition from the low level L to the high level H.

The transmission transistor TX1 may be turned on by the transmission control signal TG1 of the high level H. Accordingly, the photoelectric charges generated in the photoelectric device PD1 during an integration period T3 from t307 to t309 may be transferred to the first floating diffusion node FD10. The first driving transistor SF1 may buffer an image voltage accumulated in the first floating diffusion FD10 to the first output node N1. Herein, the image voltage may be a voltage generated in the first floating diffusion FD10 by the photoelectric charges generated during the integration period T0.

At t309, the transmission control signal TG1 may transition from the high level H to the low level L.

At t307 to t311, a second ramp signal R92 having a second period that is greater than the first period may be provided to the comparator 8031 in synchronization with the target signal to be compared. The comparator 8031 may output a result of comparing the pixel signal corresponding to the image voltage, which is the target signal to be compared, with the second ramp signal R92 based on the clock signal CLK.

The counter 8033 may count a comparison result thereof received from the comparator 8031 to generate the image data IDAT corresponding to the image voltage.

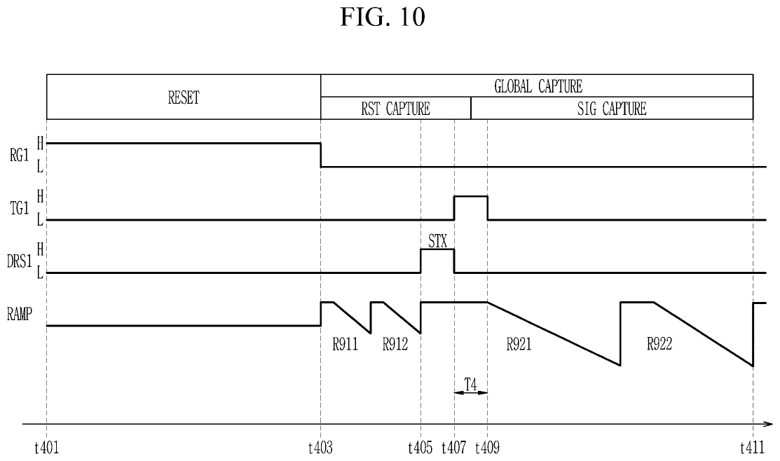

FIG. 10 illustrates a timing diagram showing an example of an operation of an image sensor according to FIG. 8 according to some implementations. FIG. 10 illustrates a timing diagram showing the global shutter period (GLOBAL SHUTTER) t401 to t405 and the global capture period (GLOBAL CAPTURE) t405 to t411 of the image sensor. Unless otherwise stated, the description of the global shutter period (GLOBAL SHUTTER) t301 to t305 and the global capture period (GLOBAL CAPTURE) t305 to t311 provided with reference to FIG. 9 may be applied to the global shutter period (GLOBAL SHUTTER) t401 to t405 and the global capture period (GLOBAL CAPTURE) t405 to t411.

In some implementations, the image sensor 100 may operate in an LN mode. When operating in a low noise mode, the image sensor 100 may compare a pixel signal and a corresponding lamp signal multiple times, and may generate image data corresponding to the pixel signal based on multiple comparison results thereof. In some implementations, the image sensor 100 may apply a multi-sampling technique to average or remove noise occurring in each of the comparison results. The image sensor 100 may improve accuracy of pixel signals. FIG. 10 illustrates a timing diagram showing an operation of image sensor 100 when operating in a LN2 mode. In FIG. 10, the ramp signal generator 160 may generate a ramp signal RAMP including two first ramp signals R911 and R912 and two second ramp signals R921 and R922. For example, the first ramp signals R911 and R912 may be a ramp signal for comparison with the pixel signal corresponding to the reset voltage. The second ramp signals R921 and R922 may be a ramp signal for comparison with the pixel signal corresponding to the image voltage. The image sensor 100 may generate accurate image data IDAT based on multiple comparison results. For example, the image sensor 100 may calculate an average value of the comparison results, and may determine the average value as the image data IDAT.

At t403 to t405, the image sensor 100 may compare the pixel signals corresponding to the plurality of first lamp signals R911 and R912 to generate a plurality of comparison results.

For example, the first ramp signal R911 and a first pixel signal corresponding to the reset voltage, which is the target signal to be compared, may be provided synchronously to the comparator 8031, and the comparator 8031 may compare the first ramp signal R911 and the first pixel signal to generate a first comparison result. Thereafter, the comparator 8031 may be provided with the first ramp signal R912 and a second pixel signal corresponding to the reset voltage in synchronization, and the comparator 8031 may compare the first ramp signal R912 and the second pixel signal to generate a second comparison result. The first pixel signal and the second pixel signal may be signals according to the reset voltage corresponding to the power supply voltage VPIX. Thereafter, the image sensor 100 may determine an average value of the first comparison result and the second comparison result as the pixel signal corresponding to the reset voltage.

At t409 to t411, the image sensor 100 may compare the pixel signals corresponding to the plurality of second lamp signals R921 and R922 to generate a plurality of comparison results.

For example, the second ramp signal R921 and a third pixel signal corresponding to the image voltage, which is the target signal to be compared, may be provided synchronously to the comparator 8031, and the comparator 8031 may compare the second ramp signal R921 and the third pixel signal to generate a third comparison result. Thereafter, the comparator 8031 may be provided with the second ramp signal R922 and a fourth pixel signal corresponding to the image voltage in synchronization, and the comparator 8031 may compare the second ramp signal R922 and the fourth pixel signal to generate a fourth comparison result. The third pixel signal and the fourth pixel signal may be signals according to the image voltage based on photoelectric charges generated by the photoelectric device PD1. Thereafter, the image sensor 100 may determine an average value of the third comparison result and the fourth comparison result as the pixel signal corresponding to the image voltage.

Meanwhile, the integration period may be from a time when the pulse STX transitions to the low level L to a time when the transmission control signal TG1 transitions to the low level L. Accordingly, a shortest integration period that the image sensor can have may be a first period T4. During the first period T4, depending on intensity of light incident on the image sensor, photoelectric charges may be generated in the photoelectric device PD, and the generated photoelectric charges may be accumulated in the first floating diffusion node FD10.

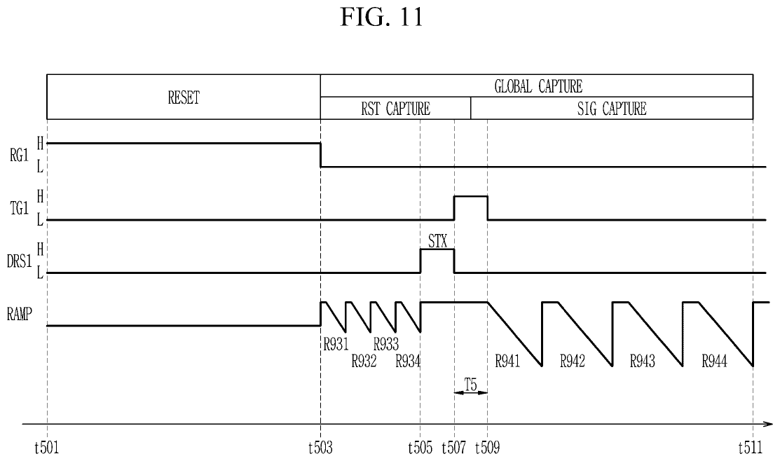

FIG. 11 illustrates a timing diagram showing an example of an operation of an image sensor according to FIG. 8 according to some implementations. In FIG. 11, a timing diagram shows the global shutter period (GLOBAL SHUTTER) t501 to t505 and the global capture period (GLOBAL CAPTURE) t505 to t511 of the image sensor. Unless otherwise stated, the description of the global shutter period (GLOBAL SHUTTER) t301 to t305 and the global capture period (GLOBAL CAPTURE) t305 to t311 provided with reference to FIG. 9 may be applied to the global shutter period (GLOBAL SHUTTER) t501 to t505 and the global capture period (GLOBAL CAPTURE) t505 to t511.

In some implementations, the image sensor 100 may operate in an LN mode. FIG. 11 illustrates a timing diagram showing an operation of image sensor 100 when operating in an LN4 mode. In FIG. 11, the ramp signal generator 160 may generate a ramp signal RAMP including four first lamp signals R931, R932, R933, and R934 and four second ramp signals R941, R942, R943, and R944. For example, the first ramp signals R931, R932, and R933 may be a ramp signal for comparison with the pixel signal corresponding to the reset voltage. The second ramp signals R941, R942 R943, and R944 may be a ramp signal for comparison with the pixel signal corresponding to the image voltage. The image sensor 100 may generate accurate image data IDAT based on multiple comparison results. For example, the image sensor 100 may calculate an average value of the comparison results, and may determine the average value as the image data IDAT.

At t503 to t505, the image sensor 100 may compare the pixel signals corresponding to the four first lamp signals R931, R932, R933, and R934 to generate a plurality of comparison results.

For example, the first ramp signal R931 and a first pixel signal corresponding to the reset voltage, which is the target signal to be compared, may be provided synchronously to the comparator 8031, and the comparator 8031 may compare the first ramp signal R931 and the first pixel signal to generate a first comparison result. Thereafter, the comparator 8031 may be provided with the first ramp signal R932 and a second pixel signal corresponding to the reset voltage in synchronization, and the comparator 8031 may compare the first ramp signal R932 and the second pixel signal to generate a second comparison result. The comparator 8031 may be provided with the first ramp signal R933 and a third pixel signal corresponding to the reset voltage in synchronization, and the comparator 8031 may compare the first ramp signal R933 and the third pixel signal to generate a third comparison result. The comparator 8031 may be provided with the first ramp signal R934 and a fourth pixel signal corresponding to the reset voltage in synchronization, and the comparator 8031 may compare the first ramp signal R934 and the fourth pixel signal to generate a fourth comparison result.

The first pixel signal, the second pixel signal, the third pixel signal, and the fourth pixel signal may be signals according to the reset voltage corresponding to the power supply voltage VPIX. Thereafter, the image sensor 100 may determine an average value of the first comparison result, the second comparison result, the third comparison result, and the fourth comparison result as the pixel signal corresponding to the reset voltage.

At t409 to t411, the image sensor 100 may compare the pixel signals corresponding to the four second lamp signals R941, R942, R943, and R944 to generate a plurality of comparison results.

For example, the second ramp signal R941 and a fifth pixel signal corresponding to the image voltage, which is the target signal to be compared, may be provided synchronously to the comparator 8031, and the comparator 8031 may compare the second ramp signal R941 and the fifth pixel signal to generate a fifth comparison result. Thereafter, the comparator 8031 may be provided with the second ramp signal R942 and a sixth pixel signal corresponding to the image voltage in synchronization, and the comparator 8031 may compare the second ramp signal R942 and the sixth pixel signal to generate a sixth comparison result. The comparator 8031 may be provided with the second ramp signal R943 and a seventh pixel signal corresponding to the image voltage in synchronization, and the comparator 8031 may compare the second ramp signal R943 and the seventh pixel signal to generate a seventh comparison result. The comparator 8031 may be provided with the second ramp signal R944 and an eighth pixel signal corresponding to the image voltage in synchronization, and the comparator 8031 may compare the second ramp signal R944 and the eighth pixel signal to generate an eighth comparison result.

The fifth pixel signal, the sixth pixel signal, the seventh pixel signal, and the eighth pixel signal may be signals according to the image voltage based on photoelectric charges generated by the photoelectric device PD1. Thereafter, the image sensor 100 may determine an average value of the fifth comparison result, the sixth comparison result, the seventh comparison result, and the eighth comparison result as the pixel signal corresponding to the image voltage.

Meanwhile, the integration period may be from a time when the pulse STX transitions to the low level L to a time when the transmission control signal TG1 transitions to the low level L. Accordingly, a shortest integration period that the image sensor can have may be a first period T5. During the first period T5, depending on intensity of light incident on the image sensor, photoelectric charges may be generated in the photoelectric device PD, and the generated photoelectric charges may be accumulated in the first floating diffusion node FD10.

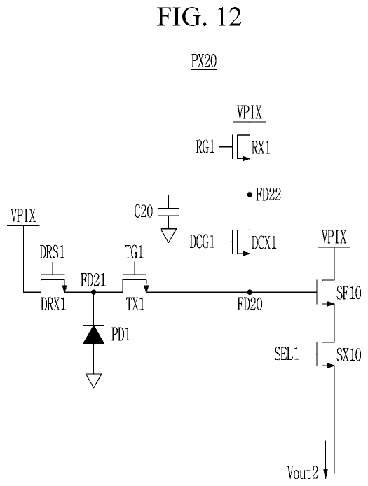

FIG. 12 illustrates an example of a pixel according to some implementations. In FIG. 12, the pixel PX20 may include a photoelectric device PD1, a drain transistor DRX1, a transmission transistor TX1, a reset transistor RX1, a first driving transistor SF10, a first gain control transistor DCX1, a first selection transistor SX10, and a capacitor C20.

Unless otherwise stated, the description of the pixel PX10 provided with reference to FIG. 4 may also be applied to the pixel PX20.

The photoelectric device PD1 may generate photoelectric charges proportional to intensity of light. The photoelectric device PD1 may be connected to the second floating diffusion node FD21.

The second floating diffusion node FD21 may receive charge from the photoelectric device PD1, and may accumulate the received charge. A parasitic capacitor may be formed at the second floating diffusion node FD21, or an actual capacitor element may be connected thereto.

The first floating diffusion node FD20 may receive charge from the photoelectric device PD1 through the transmission transistor TX1, and may accumulate the received charge. A parasitic capacitor may be formed at the first floating diffusion node FD20, or an actual capacitor element may be connected thereto. Depending on an amount of charges accumulated in the first floating diffusion node FD20, potential of a gate electrode of the first driving transistor SF10 may vary.

The first gain control transistor DCX1 may be connected between the first floating diffusion node FD20 and the third floating diffusion node FD22, and may be controlled by the first gain control signal DCG1.

The capacitor C20 may be connected between the third floating diffusion node FD22 and the ground power supply. The capacitor C20 may have a predetermined capacitance, and may store the charge generated by a photodiode PD.

When the first gain control transistor DCX1 is turned off, the first floating diffusion node FD20 may have capacitance of the first floating diffusion node FD20. In this case, a magnitude of the capacitance connected to the first floating diffusion node FD20 is small, the image sensor 100 may generate an image signal in a high conversion gain mode. When operating in high conversion gain mode, a gain of the readout circuit 150 for processing pixel signals may be relatively reduced.

When the first gain control transistor DCX1 is turned on, the third floating diffusion node FD22 may be connected to the first floating diffusion node FD20, and the capacitance of the first floating diffusion node FD20 may increase by capacitance of the capacitor C20. In this case, a magnitude of the capacitance connected to the first floating diffusion node FD20 is great, the image sensor 100 may generate an image signal in a low conversion gain mode LCG. When operating in the low conversion gain mode, an amount of charge that can be handled within a pixel, i.e., a full well capacity (FWC), may be increased. Accordingly, a high light detection performance of the image sensor 100 may be improved.

A gate of the first driving transistor SF10 may be connected to the first floating diffusion node FD10. A gate terminal of the first driving transistor SF10 may be connected to the first floating diffusion node FD20. The first driving transistor SF10 may operate as a source-follower amplifier for a voltage of the first floating diffusion node FD10. The first driving transistor SF10 may output a voltage of the first floating diffusion node FD10 as a pixel signal Vout2 through the selection transistor SX10.

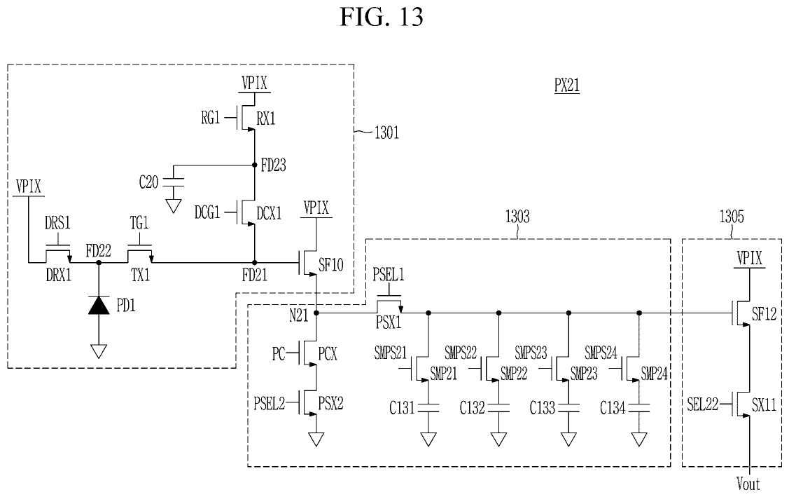

FIG. 13 illustrates a circuit diagram showing an example of a pixel according to some implementations. In FIG. 13, the pixel PX21 may include a photoelectric charge generating circuit 1301, a sampling circuit 1303, and a pixel signal generating circuit 1305.

The photoelectric charge generating circuit 1301 may transfer a photoelectric charge generated by a photoelectric device PD1 to the sampling circuit 1303. Specifically, the photoelectric charge generating circuit 1301 may include a photoelectric device PD1, a drain transistor DRX1, a transmission transistor TX1, a reset transistor RX1, a first driving transistor SF10, a first gain control transistor DCX1, and a capacitor C20. Unless otherwise stated, the description of the pixel PX20 of FIG. 12 may be equally applied to the photoelectric charge generating circuit 1301.

The sampling circuit 1303 may include a precharge transistor PCX, a first precharge transistor PSX1, a second precharge selection transistor PSX2, a first sampling transistor SMP21, a second sampling transistor SMP22, a third sampling transistor SMP23, a fourth sampling transistor SMP24, a first capacitor C131, a second capacitor C132, a third capacitor C133, and a fourth capacitor C134. Unless otherwise stated, the description of the sampling circuit 503 provided with reference to FIG. 5 may also be applied to the sampling circuit 1303.

The precharge transistor PCX may be connected between the first output node N21 and the second precharge selection transistor PSX2. A first terminal of the precharge transistor PCX may be connected to the first output node N21, and a second terminal may be connected to the second precharge select transistor PSX2. The precharge transistor PCX may be controlled by a precharge control signal PC.

The first precharge transistor PSX1 may be connected between the first output node N11 and a second output node N12. The first precharge selection transistor PSX1 may be controlled by a first precharge selection control signal PSEL1.

The second precharge selection transistor PSX2 may be connected between the precharge transistor PCX and a ground voltage. A first terminal of the second precharge selection transistor PSX2 may be connected to the first output node N11, and the ground voltage may be applied to a second terminal of the second precharge selection transistor PSX2. The second precharge selection transistor PSX2 may be controlled by a second precharge selection control signal PSEL2.

The first sampling transistor SMP21 may be connected between the second output node N22 and a first capacitor C131. A first terminal of the first sampling transistor SMP21 may be connected to the second output node N22, and a second terminal of the first sampling transistor SMP21 may be connected to the first capacitor C131. The first sampling transistor SMP21 may be controlled by the first sampling control signal SMPS21. When the first sampling transistor SMP21 is turned on, the first capacitor C131 and the second output node N22 may be connected, and an electrical signal of the second output node N22 may be sampled.

The ground voltage may be applied to a first terminal of the first capacitor C131, and a second terminal of the first capacitor C131 may be connected to the first sampling transistor SMP21. Charges may be accumulated in the first capacitor C131 according to a switching operation of the first sampling transistor SMP21. The first capacitor C131 may accumulate charges corresponding to a signal buffered according to an amount of charges charged to the first floating diffusion node FD20. For example, when the image sensor 100 operates in the low conversion gain mode, the first capacitor C131 may accumulate charges corresponding to a signal buffered based on a charge amount of the first floating diffusion FD20 that is reset during the global shutter period.

The second sampling transistor SMP22 may be connected to the second output node N22 and the first capacitor C132. A first terminal of the second sampling transistor SMP22 may be connected to the second output node N22, and a second terminal of the second sampling transistor SMP22 may be connected to the first capacitor C132. The second sampling transistor SMP22 may be controlled by the second sampling control signal SMPS22. When the second sampling transistor SMP22 is turned on, the second capacitor C132 and the second output node N22 may be connected, and an electrical signal of the second output node N22 may be sampled.

The ground voltage may be applied to a first terminal of the second capacitor C132, and a second terminal of the second capacitor C132 may be connected to the second sampling transistor SMP22. Charges may be accumulated in the second capacitor C132 according to a switching operation of the second sampling transistor SMP22. The second capacitor C132 may accumulate charges corresponding to a signal buffered according to an amount of charges charged to the first floating diffusion node FD20. For example, when the image sensor 100 operates in the high conversion gain mode, the second capacitor C132 may accumulate charges corresponding to a signal buffered based on a charge amount of the first floating diffusion FD20 that is reset during the global shutter period.

The third sampling transistor SMP23 may be connected between the second output node N22 and the third first capacitor C133. A first terminal of the third sampling transistor SMP23 may be connected to the second output node N22, and a second terminal of the third sampling transistor SMP23 may be connected to the third capacitor C133. The third sampling transistor SMP23 may be controlled by the first sampling control signal SMPS23. When the third sampling transistor SMP23 is turned on, the third capacitor C133 and the second output node N22 may be connected, and an electrical signal of the second output node N22 may be sampled.

A ground voltage may be applied to a first terminal of the third capacitor C133, and a second terminal of the third capacitor C133 may be connected to the third sampling transistor SMP23. Charges may be accumulated in the third capacitor C133 according to a switching operation of the third sampling transistor SMP23. The third capacitor C133 may accumulate charges corresponding to a signal buffered according to an amount of charges charged to the first floating diffusion node FD20. For example, when the image sensor 100 operates in the high conversion gain mode, the third capacitor C133 may accumulate charges corresponding to a signal buffered based on a charge amount of the first floating diffusion FD20 that is reset during the integration period.

The fourth sampling transistor SMP24 may be connected to the second output node N22 and the fourth capacitor C134. A first terminal of the fourth sampling transistor SMP24 may be connected to the second output node N22, and a second terminal of the fourth sampling transistor SMP24 may be connected to the fourth capacitor C134. The fourth sampling transistor SMP24 may be controlled by the second sampling control signal SMPS24. When the fourth sampling transistor SMP24 is turned on, the fourth capacitor C134 and the second output node N22 may be connected, and an electrical signal of the second output node N22 may be sampled.

The ground voltage may be applied to a first terminal of the fourth capacitor C134, and a second terminal of the fourth capacitor C134 may be connected to the second sampling transistor SMP24. Charges may be accumulated in the fourth capacitor C134 according to a switching operation of the fourth sampling transistor SMP24. The fourth capacitor C134 may accumulate charges corresponding to a signal buffered according to an amount of charges charged to the first floating diffusion node FD20. For example, when the image sensor 100 operates in the low conversion gain mode, the fourth capacitor C134 may accumulate charges corresponding to a signal buffered based on a charge amount of the first floating diffusion FD20 that is reset during the integration period.

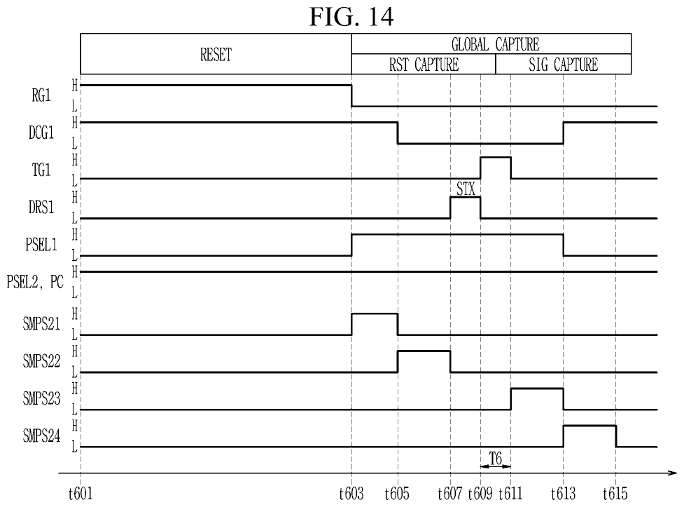

FIG. 14 illustrates a timing diagram showing an example of an operation of the pixel according to FIG. 13 according to some implementations. In FIG. 14, a timing diagram shows the global shutter period (GLOBAL SHUTTER) t601 to t603 and the global capture period (GLOBAL CAPTURE) t603 to t615 of the image sensor.

In FIG. 14, the image sensor 100 is illustrated as including four sampling transistors, but the present disclosure is not limited thereto, and the image sensor 100 may include a plurality of sampling transistors.

The pixel signal circuit 505 may include a second driving transistor SF12 and a selection transistor SX11. Unless otherwise stated, the description of the pixel signal circuit 505 illustrated in FIG. 5 may so be applied to the pixel signal circuit 1305.

During the global shutter period t601 to t603, the charges stored in the photoelectric device PD1 and the first floating diffusion node FD20 may be reset.

Unless otherwise stated, the description of the global shutter period (GLOBAL SHUTTER) t201 to t203 provided with reference to FIG. 6 may also be applied to the global shutter period (GLOBAL SHUTTER) t601 to t603. At t601 to t603, the gain control signal DCG1 may have the high level H.

The global capture period (GLOBAL CAPTURE) t603 to t615 may be a period for sampling the charges accumulated in the first floating diffusion node FD10.

At t603, the reset control signal RG1 may transition from the high level H to the low level L. The first precharge selection control signal PSEL1 and the first sampling control signal SMPS21 may transition from the low level L to the high level H.

At t603 to t605, the gain control signal DCG1 may have the high level H, so the image sensor 100 may operate in the low conversion gain (LCG) mode.

Meanwhile, the first floating diffusion node FD20 may be reset to the power supply voltage VPIX. The first driving transistor SF1 may buffer a reset voltage corresponding to the power supply voltage VPIX of the first floating diffusion node FD20 to the first output node N21. The first precharge selection transistor PSX1 may be turned on by the first precharge selection control signal PSEL1 of the high level H. Accordingly, the reset voltage buffered in the first output node N21 may be transferred to the second output node N22.

The first sampling transistor SMP21 may be turned on by the first sampling control signal SMPS21 of the high level H. Accordingly, the first capacitor C21 may sample a signal of the second output node N22. That is, the first capacitor C21 may sample a reset voltage of the low conversion gain (LCG) mode.

At t605, the gain control signal DCG1 and the first sampling control signal SMPS21 may transition from the high level H to the low level L, and the second sampling control signal SMPS22 transition from the low level L to the high level H.

At t605 to t607, the gain control signal DCG1 may have the low level L, so the image sensor 100 may operate in the high conversion gain mode.

The second sampling transistor SMP22 may be turned on by the second sampling control signal SMPS22 of the high level H. Accordingly, the second capacitor C22 may sample a signal of the second output node N22. That is, the second capacitor C22 may sample a reset voltage of the high conversion gain (HCG) mode.

At t607, the drain control signal DRS1 may transition to an arbitrary pulse shape STX. In addition, the second sampling control signal SMPS22 may transition from the high level H to the low level L. In FIG. 14, the drain control signal DRS1 is illustrated as transitioning from the low level L to the high level H at t607, but the present disclosure is not limited thereto, and the drain control signal DRS1 may transition in the arbitrary pulse shape STX at any time point from t601 to t609.

At t609, the drain control signal DRS1 may transition from the high level H to the low level L, and the transmission control signal TG1 may transition from the low level L to the high level H.

At t609 to t611, the transmission transistor TX may be turned on by the transmission control signal TG1 of the high level H. Accordingly, the photoelectric charges generated in the photoelectric device PD1 during an integration period T6 from t609 to t611 may be transferred to the first floating diffusion node FD20. The first driving transistor SF1 may buffer an image voltage accumulated in the first floating diffusion node FD20 to the first output node N21. Herein, the image voltage may be a voltage generated in the first floating diffusion node FD20 by the photoelectric charges generated during the integration period T6.

The first precharge transistor PSX1 may be turned on by the first precharge selection control signal PSEL1 of the high level H. Accordingly, the image voltage buffered at the first output node N21 by the first driving transistor SF1 may be transferred to the second output node N22.

At t611, the transmission control signal TG1 may transition from the high level H to the low level L, and the third sampling control signal SMP23 may transition from the low level L to the high level H.

At t611 to t613, the gain control signal DCG1 may have the low level L, so the image sensor 100 may operate in the high conversion gain mode.

The third sampling transistor SMP23 may be turned on by the second sampling control signal SMPS23 of the high level H. Accordingly, the third capacitor C23 may sample a signal of the second output node N22. That is, the third capacitor C23 may sample an image voltage of the high conversion gain (HCG) mode.

At t613, the gain control signal DCG1 and the fourth sampling control signal SMP24 may transition from the low level L to the high level H. In addition, the third sampling control signal SMP23 may transition from the high level H to the low level L.

At t613 to t615, the gain control signal DCG1 may have the high level H, so the image sensor 100 may operate in the low conversion gain mode.

The fourth sampling transistor SMP24 may be turned on by the fourth sampling control signal SMPS24 of the high level H. Accordingly, the fourth capacitor C24 may sample a signal of the second output node N22. That is, the fourth capacitor C24 may sample an image voltage of the low conversion gain (LCG) mode.

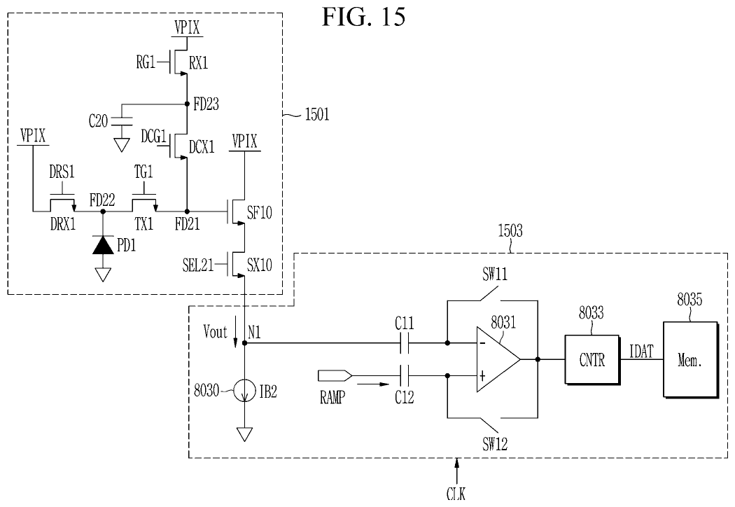

FIG. 15 illustrates a circuit diagram showing examples of a pixel and a readout circuit according to some implementations. In FIG. 15, an image sensor 100 may include a photoelectric charge generating circuit 1501 and a readout circuit 1503. The readout circuit 1503 may convert the pixel signal Vout generated by the photoelectric charge generating circuit 1501 into a pixel value. A pixel value may be image data having multiple bits.

The photoelectric charge generating circuit 1501 may output a photoelectric charge generated by the photoelectric device PD1 to a first node N1. Specifically, the photoelectric charge generating circuit 1501 may include the photoelectric device PD1, a transmission transistor TX, a reset transistor RX, and a first driving transistor SF10. Unless otherwise stated, the description of the pixel PX20 of FIG. 12 may be equally applied to the photoelectric charge generating circuit 1501.

The readout circuit 1503 may be connected to the first node N1. The readout circuit 1503 may include a first current source 8030, a comparator 8031, a counter circuit 8033, and a memory 8035. Unless otherwise stated, the description of the readout circuit 803 of FIG. 8 may be applied to the readout circuit 1503.

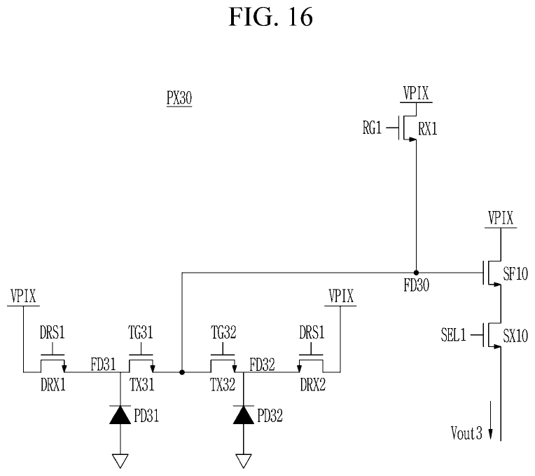

FIG. 16 illustrates an example of a pixel according to some implementations. In FIG. 16, the pixel PX30 may include a photoelectric device PD1, a first drain transistor DRX1, a second drain transistor DRX2, a first transmission transistor TX31, a second transmission transistor TX32, a reset transistor RX1, a first driving transistor SF10, and a first selection transistor SX10.

Unless otherwise stated, the description of the pixel PX10 provided with reference to FIG. 4 may also be applied to the pixel PX30.

The first photoelectric device PD31 may generate photoelectric charges proportional to intensity of light. The first photoelectric device PD31 may be connected to the second floating diffusion node FD31. The second photoelectric device PD32 may generate photoelectric charges proportional to intensity of light. The second photoelectric device PD32 may be connected to the third floating diffusion node FD32.

The first photoelectric device PD31 and the second photoelectric device PD32 may be positioned adjacent to each other. In some implementations, the first photoelectric device PD31 and the second photoelectric device PD32 may be arranged under one microlens. For example, the first photoelectric device PD31 may sense a left-side image of an object, and the second photoelectric device PD32 may sense a right-side image of the object. Charges generated from the first photoelectric device PD31 and the second photoelectric device PD32 may be accumulated in the first floating diffusion node FD30.

The second floating diffusion node FD31 may receive charge from the first photoelectric device PD31, and may accumulate the received charge. A parasitic capacitor may be formed at the second floating diffusion node FD31, or an actual capacitor element may be connected thereto.

The third floating diffusion node FD32 may receive charge from the second photoelectric device PD32, and may accumulate the received charge. A parasitic capacitor may be formed at the third floating diffusion node FD32, or an actual capacitor element may be connected thereto.

The first transmission transistor TX31 may be connected between the first floating diffusion node FD30 and the second floating diffusion node FD31, and may be controlled by a first transmission control signal TG31. A first terminal of the first transmission transistor TX31 may be connected to an output terminal of the first photoelectric device PD31, and a second terminal of the first transmission transistor TX31 may be connected to the first floating diffusion node FD30. The first transmission transistor TX31 may be controlled by the first transmission control signal TG31 and/or a shutter control signal. When the first transmission transistor TX31 is turned on, the charges generated in the first photoelectric device PD31 may be transmitted to the first floating diffusion node FD30.

The second transmission transistor TX32 may be connected between the first floating diffusion node FD30 and the third floating diffusion node FD32, and may be controlled by a second transmission control signal TG32. A first terminal of the second transmission transistor TX32 may be connected to an output terminal of the second photoelectric device PD32, and a second terminal of the second transmission transistor TX32 may be connected to the first floating diffusion node FD30. The second transmission transistor TX32 may be controlled by the second transmission control signal TG32 and/or a shutter control signal. When the second transmission transistor TX32 is turned on, the charges generated in the second photoelectric device PD32 may be transmitted to the first floating diffusion node FD30.

The first floating diffusion node FD30 may receive charges from the first photoelectric device PD31 and the second photoelectric device PD32 through the first transmission transistor TX31 and the second transmission transistor TX32, and may accumulate the received charges. A parasitic capacitor may be formed at the first floating diffusion node FD30, or an actual capacitor element may be connected thereto. Depending on an amount of charges accumulated in the first floating diffusion node FD30, potential of a gate electrode of the first driving transistor SF10 may vary.

The first drain transistor DRX1 may be connected between the second floating diffusion node FD31 and a power supply voltage VPIX.

The first drain transistor DRX1 may be connected between the second floating diffusion node FD31 and a power supply voltage VPIX. A first terminal of the first drain transistor DRX1 may be connected to an output terminal of the first photoelectric device PD31, and a second terminal of the first drain transistor DRX1 may be connected to the power supply voltage VPIX. The first drain transistor DRX1 may be controlled by a drain control signal DRS1. When the first drain transistor DRX1 is turned on, the second floating diffusion node FD31 may be set to the power supply voltage VPIX.

The second drain transistor DRX2 may be connected between the third floating diffusion node FD32 and the power supply voltage VPIX.

The second drain transistor DRX2 may be connected between the second floating node FD32 and the power supply voltage VPIX. A first terminal of the second drain transistor DRX2 may be connected to an output terminal of the second photoelectric device PD32, and a second terminal of the second drain transistor DRX2 may be connected to the power supply voltage VPIX. The second drain transistor DRX2 may be controlled by the drain control signal DRS1. When the second drain transistor DRX2 is turned on, the third floating diffusion node FD32 may be set to the power supply voltage VPIX.

A gate of the first driving transistor SF10 may be connected to the first floating diffusion node FD30. A gate terminal of the first driving transistor SF30 may be connected to the first floating diffusion node FD30. The first driving transistor SF10 may operate as a source-follower amplifier for a voltage of the first floating diffusion node FD30. The first driving transistor SF10 may output a voltage of the first floating diffusion node FD30 as a pixel signal Vout3 through the selection transistor SX10.

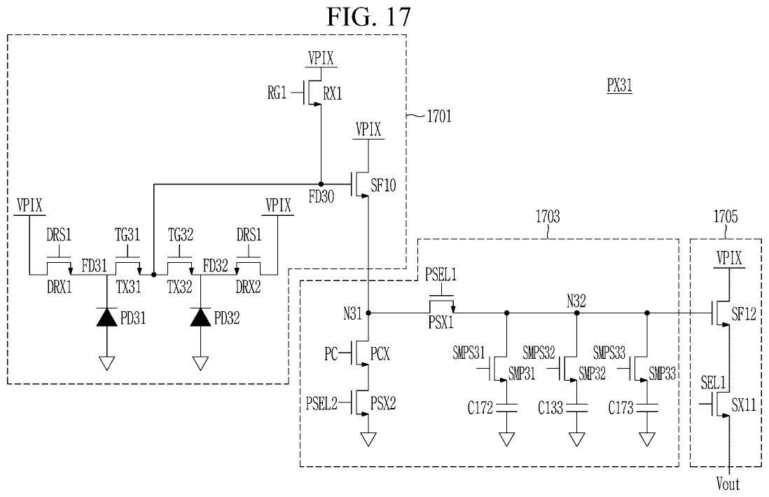

FIG. 17 illustrates an example of a pixel according to some implementations. In FIG. 17, the pixel PX31 may include a photoelectric charge generating circuit 1701, a sampling circuit 1703, and a pixel signal generating circuit 1705.

The photoelectric charge generating circuit 1701 may transfer a photoelectric charge generated by the first photoelectric device PD31 and the second photoelectric device PD32 to the sampling circuit 1303. Specifically, the photoelectric charge generating circuit 1301 may include a first photoelectric device PD31, a second photoelectric device PD32, a first drain transistor DRX1, a second drain transistor DRX2, a first transmission transistor TX31, a second transmission transistor TX32, a reset transistor RX1, and a first driving transistor SF10. Unless otherwise stated, the description of the pixel PX30 of FIG. 16 may be equally applied to the photoelectric charge generating circuit 1701.

The sampling circuit 1303 may include a precharge transistor PCX, a first precharge transistor PSX1, a second precharge selection transistor PSX2, a first sampling transistor SMP31, a second sampling transistor SMP32, a third sampling transistor SMP33, a first capacitor C171, a second capacitor C172, and a third capacitor C173. Unless otherwise stated, the description of the sampling circuit 503 provided with reference to FIG. 5 may also be applied to the sampling circuit 1703.

The precharge transistor PCX may be connected between the first output node N31 and the second precharge selection transistor PSX2. A first terminal of the precharge transistor PCX may be connected to the first output node N31, and a second terminal may be connected to the second precharge select transistor PSX2. The precharge transistor PCX may be controlled by a precharge control signal PC.

The first precharge transistor PSX1 may be connected between the first output node N31 and a second output node N32. The first precharge selection transistor PSX1 may be controlled by a first precharge selection control signal PSEL1.

The second precharge selection transistor PSX2 may be connected between the precharge transistor PCX and a ground voltage. A first terminal of the second precharge selection transistor PSX2 may be connected to the first output node N31, and the ground voltage may be applied to a second terminal of the second precharge selection transistor PSX2. The second precharge selection transistor PSX2 may be controlled by a second precharge selection control signal PSEL2.

The first sampling transistor SMP31 may be connected between the second output node N32 and a first capacitor C171. A first terminal of the first sampling transistor SMP31 may be connected to the second output node N32, and a second terminal of the first sampling transistor SMP31 may be connected to the first capacitor C171. The first sampling transistor SMP31 may be controlled by the first sampling control signal SMPS31. When the first sampling transistor SMP31 is turned on, the first capacitor C171 and the second output node N32 may be connected, and an electrical signal of the second output node N32 may be sampled.

The ground voltage may be applied to a first terminal of the first capacitor C171, and a second terminal of the first capacitor C171 may be connected to the first sampling transistor SMP31. Charges may be accumulated in the first capacitor C171 according to a switching operation of the first sampling transistor SMP31. The first capacitor C171 may accumulate charges corresponding to a signal buffered according to an amount of charges charged to the first floating diffusion node FD30. For example, the first capacitor C171 may accumulate charges corresponding to a signal buffered based on a charge amount of the first floating diffusion FD30 that is reset during the global shutter period.

The second sampling transistor SMP32 may be connected to the second output node N32 and the first capacitor C172. A first terminal of the second sampling transistor SMP32 may be connected to the second output node N32, and a second terminal of the second sampling transistor SMP32 may be connected to the first capacitor C172. The second sampling transistor SMP32 may be controlled by the second sampling control signal SMPS32. When the second sampling transistor SMP32 is turned on, the second capacitor C172 and the second output node N32 may be connected, and an electrical signal of the second output node N32 may be sampled.

The ground voltage may be applied to a first terminal of the second capacitor C172, and a second terminal of the second capacitor C172 may be connected to the second sampling transistor SMP32. Charges may be accumulated in the second capacitor C172 according to a switching operation of the second sampling transistor SMP32. The second capacitor C172 may accumulate charges corresponding to a signal buffered according to an amount of charges charged to the first floating diffusion node FD30. For example, the second capacitor C172 may accumulate charges corresponding to a signal buffered based on a charge amount of the first floating diffusion FD30 generated from the first photoelectric device PD31 during the integration period.

The third sampling transistor SMP33 may be connected between the second output node N32 and the third first capacitor C173. A first terminal of the third sampling transistor SMP33 may be connected to the second output node N32, and a second terminal of the third sampling transistor SMP33 may be connected to the third capacitor C173. The third sampling transistor SMP33 may be controlled by the first sampling control signal SMPS33. When the third sampling transistor SMP33 is turned on, the third capacitor C173 and the second output node N32 may be connected, and an electrical signal of the second output node N32 may be sampled.

A ground voltage may be applied to a first terminal of the third capacitor C173, and a second terminal of the third capacitor C173 may be connected to the third sampling transistor SMP33. Charges may be accumulated in the third capacitor C173 according to a switching operation of the third sampling transistor SMP33. The third capacitor C173 may accumulate charges corresponding to a signal buffered according to an amount of charges charged to the first floating diffusion node FD20. For example, the third capacitor C173 may accumulate charges corresponding to a signal buffered based on a charge amount of the first floating diffusion FD30 generated from the first photoelectric device PD31 and the second photoelectric device PD32 during the integration period.

In FIG. 17, the image sensor 100 is illustrated as including three sampling transistors, but the present disclosure is not limited thereto, and the image sensor 100 may include a plurality of sampling transistors.

The pixel signal circuit 1705 may include a second driving transistor SF12 and a selection transistor SX11. Unless otherwise stated, the description of the pixel signal circuit 505 illustrated in FIG. 5 may so be applied to the pixel signal circuit 1705.

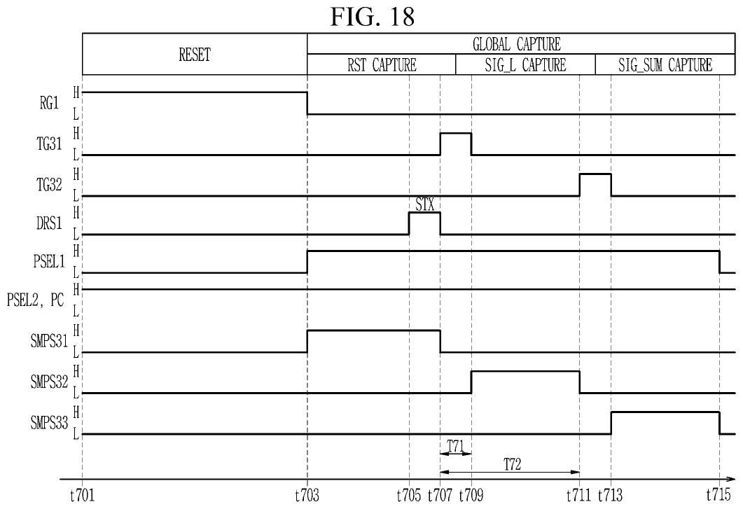

FIG. 18 illustrates a timing diagram showing an example of an operation of the pixel according to FIG. 17 according to some implementations. In FIG. 18, a timing diagram shows the global shutter period (GLOBAL SHUTTER) t701 to t703 and the global capture period (GLOBAL CAPTURE) t703 to t715 of the image sensor.

During the global shutter period t701 to t703, the charges stored in the first photoelectric device PD31, the second photoelectric device PD32, and the first floating diffusion node FD30 may be reset.

Unless otherwise stated, the description of the global shutter period (GLOBAL SHUTTER) t201 to t203 provided with reference to FIG. 6 may also be applied to the global shutter period (GLOBAL SHUTTER) t701 to t703. At t701 to t703, the first transmission control signal TG31 and the second transmission control signal TG32 may have the low level L.

At t703, the reset control signal RG1 may transition from the high level H to the low level L. The first precharge selection control signal PSEL1 and the first sampling control signal SMPS31 may transition from the low level L to the high level H.

At t703 to t705, the first floating diffusion node FD30 may be reset to the power supply voltage VPIX. The first driving transistor SF10 may buffer a reset voltage corresponding to the power supply voltage VPIX of the first floating diffusion node FD30 to the first output node N31. The first precharge selection transistor PSX1 may be turned on by the first precharge selection control signal PSEL1 of the high level H. Accordingly, the reset voltage buffered in the first output node N31 may be transferred to the second output node N31.

The first sampling transistor SMP31 may be turned on by the first sampling control signal SMPS31 of the high level H. Accordingly, the first capacitor C171 may sample a signal of the second output node N32. That is, the first capacitor C171 may sample the reset voltage.

At t705, the drain control signal DRS1 may transition to an arbitrary pulse shape STX. In addition, the second sampling control signal SMPS32 may transition from the high level H to the low level L. In FIG. 18, the drain control signal DRS1 is illustrated as transitioning from the low level L to the high level H at t705, but the present disclosure is not limited thereto, and the drain control signal DRS1 may transition in the arbitrary pulse shape STX at any time point from t701 to t707.

At t707, the drain control signal DRS1 may transition from the high level H to the low level L, and the transmission control signal TG31 may transition from the low level L to the high level H.

At t707 to t709, the transmission transistor TX31 may be turned on by the transmission control signal TG31 of the high level H. Accordingly, the photoelectric charges generated in the first photoelectric device PD31 during an integration period T6 from t707 to t709 may be transferred to the first floating diffusion node FD30. The first driving transistor SF10 may buffer an image voltage accumulated in the first floating diffusion node FD30 to the first output node N31. Herein, the image voltage may be a voltage generated in the first floating diffusion node FD30 by the photoelectric charges generated in the first photoelectric device PD31 during the integration period T71.

The first precharge transistor PSX1 may be turned on by the first precharge selection control signal PSEL1 of the high level H. Accordingly, the image voltage buffered at the first output node N31 by the first driving transistor SF1 may be transferred to the second output node N32.

At t709, the first transmission control signal TG31 may transition from the high level H to the low level L, and the second sampling control signal SMPS32 may transition from the low level L to the high level H.

At t709 to t711, the second sampling transistor SMP32 may be turned on by the second sampling control signal SMPS32 of the high level H. Accordingly, the second capacitor C172 may sample a signal of the second output node N32. That is, the second capacitor C17 may sample the image voltage corresponding to a left-side image.

At t711, the second transmission control signal TG32 may transition from the low level L to the high level H, and the third sampling control signal SMPS33 may transition from the high level H to the low level L.

At t711 to t713, the transmission transistor TX32 may be turned on by the second transmission control signal TG32 of the high level H. Accordingly, the photoelectric charges generated in the second photoelectric device PD32 during an integration period T72 from t707 to t711 may be transferred to the first floating diffusion node FD30. The first driving transistor SF10 may buffer an image voltage accumulated in the first floating diffusion node FD30 to the first output node N31. Herein, the image voltage may be photoelectric charges generated in the first photoelectric device PD31 during the integration period T71 and photoelectric charges generated in the first floating diffusion node FD30 by the second photoelectric device PD32 during the integration period T72.

At t713, the second transmission control signal TG32 may transition from the high level H to the low level L, and the third sampling control signal (SMPS33 may transition from the low level L to the high level H.

The third sampling transistor SMP33 may be turned on by the second sampling control signal SMPS33 of the high level H. Accordingly, the third capacitor C173 may sample a signal of the second output node N32. That is, the second capacitor C173 may sample the image voltages corresponding to a left-side image and a right-side image.

At t715, the third sampling control signal SMP23 may transition from the high level H to the low level L.

In FIG. 18, the photoelectric charge generated by the first photoelectric device PD31 may be sampled and the photoelectric charge generated by the first photoelectric device PD31 and the second photoelectric device PD32 may be sampled, but the present disclosure is not limited thereto, and the photoelectric charge generated by the second photoelectric device PD32 may be sampled and the photoelectric charge generated by the first photoelectric device PD31 and the second photoelectric device PD32 may be sampled.

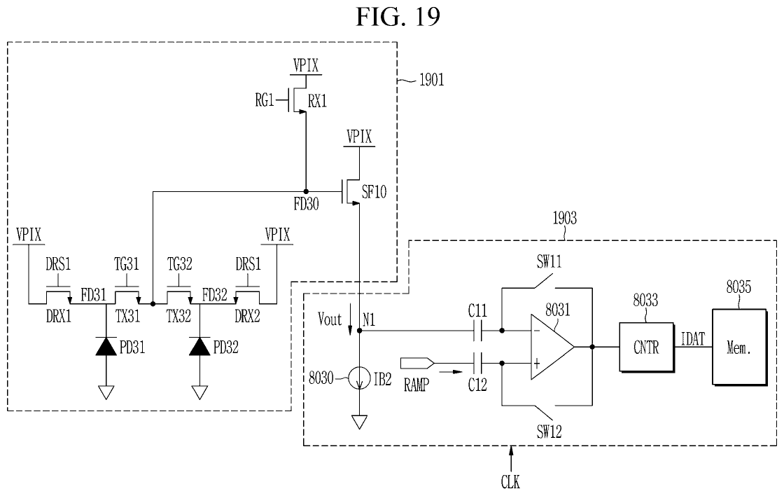

FIG. 19 illustrates a circuit diagram showing examples of a pixel and a readout circuit according to some implementations. In FIG. 19, an image sensor 100 may include a photoelectric charge generating circuit 1901 and a readout circuit 1903. The readout circuit 1903 may convert the pixel signal Vout generated by the photoelectric charge generating circuit 1901 into a pixel value. A pixel value may be image data having multiple bits.

The photoelectric charge generating circuit 1901 may output photoelectric charges generated by the first photoelectric device PD31 and the second photoelectric device PD32 to the first node N1. Specifically, the photoelectric charge generating circuit 1901 may include a first photoelectric device PD31, a second photoelectric device PD32, a first transmission transistor TX31, a second transmission transistor TX32, a reset transistor RX1, and a first driving transistor SF10. Unless otherwise stated, the description of the pixel PX30 of FIG. 16 may be equally applied to the photoelectric charge generating circuit 1901.

The readout circuit 1903 may be connected to the first node N1. The readout circuit 1903 may include a first current source 8030, a comparator 8031, a counter circuit 8033, and a memory 8035. Unless otherwise stated, the description of the readout circuit 803 of FIG. 8 may be applied to the readout circuit 1903.

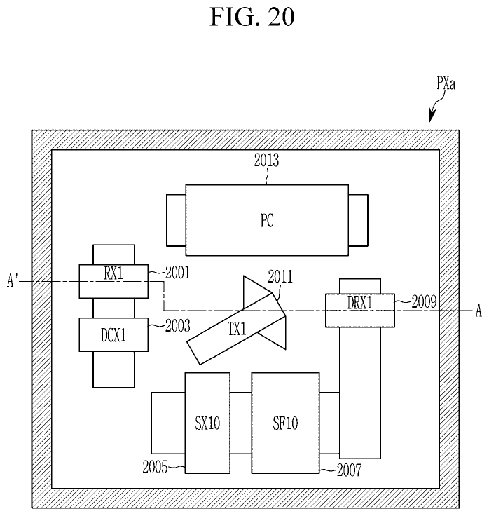

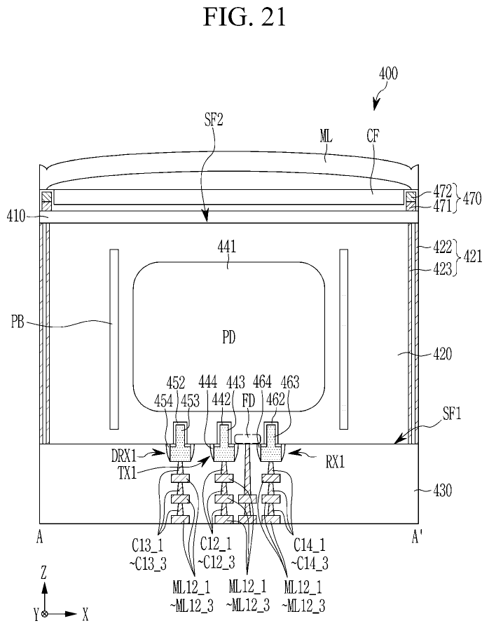

FIG. 20 illustrates a schematic top plan view of an example of a pixel according to some implementations. FIG. 21 illustrates schematic cross-sectional view of the pixel of FIG. 20 according to some implementations. Specifically, FIG. 21 illustrates a cross-sectional view of a pixel Pxa taken along a line A-A′ of FIG. 20.

In FIG. 20, a pixel Pxa may include a plurality of transistors, e.g., a first reset transistor (RX1) 2001, a first gain control transistor (DCX1) 2003, a first select transistor (SX10) 2005, a first drive transistor (SF10) 2007, a drain transistor (DRX1) 2009, a first transmission transistor (TX1) 2011, and an image processing current transistor (PC) 2013. Herein, the image processing current transistor (PC) 2013 may be configured to generate a current used during image processing, that is, power required for a chip or circuit that processes image data to operate, and may include a precharge transistor PCX and a second precharge selection transistor PSX2 of FIG. 13. Meanwhile, FIG. 20 illustrates an example in which multiple transistors can be arranged within a pixel Pxa, and the present disclosure is not limited thereto, and multiple transistors within the pixel Pxa can be arranged in all possible cases. In addition, a gate of each of the multiple transistors within the pixel Pxa may have various shapes.

In FIG. 21, a pixel array 400 may include a micro lens ML, a color filter layer CF, a surface insulating layer 410, a semiconductor substrate 420, an isolation pattern 421, and an insulating layer 430.

The micro lens ML may have a convex shape, and may have a predetermined radius of curvature. Micro lenses ML may be arranged to correspond to each pixel region.

The color filter layer CF may be disposed below the micro lens ML. The color filter layer CF may be disposed on the surface insulating layer 410. The color filter CF may be arranged to correspond to each unit pixel. Each color filter CF may be arranged two-dimensionally in a plan view. The color filter layer CF may pass reflected light incident through the micro lens ML, and may allow only light of the required wavelength to enter a photoelectric conversion region 441. The color filter layer CF may be referred to as a color filter array. In some implementations, the color filter layer CF may be omitted to acquire only color images, infrared images, or depth images.

The surface insulating layer 410 may be stacked on a second surface SF2 of the semiconductor substrate 420.

A color filter grid 470 may be positioned in a mesh shape between the color filters CF. The color filter grid 470 may define a region where the color filter CF is positioned. In some implementations, at least a portion of the color filter grid 470 may overlap the isolation pattern 421 in a third direction Z.

The color filter grid 470 may be formed on the surface insulation layer 410. The color filter grid 470 may include, e.g., a metal pattern 471 and a low refractive index pattern 472. The metal pattern 471 and the low refractive index pattern 472 may be sequentially stacked on the surface insulation layer 410.

The semiconductor substrate 420 may be, e.g., bulk silicon or silicon-on-insulator (SOI). The semiconductor substrate 420 may be a silicon substrate, or may include another material, such as silicon germanium, indium antimonide, lead telluride, indium arsenide, indium phosphide, gallium arsenide, or gallium antimonide. In some implementations, the semiconductor substrate 420 may have an epitaxial layer formed on a base substrate. In some implementations, the semiconductor substrate 420 may have a first conductivity type. For example, the first conductivity type may be p-type.

The semiconductor substrate 420 may include a first surface SF1 and a second surface SF2 that are opposite to each other. The first surface SF1 may be referred to as a front side of the semiconductor substrate 420, and the second surface SF2 may be referred to as a back side of the semiconductor substrate 420. In some implementations, the second surface SF2 of the semiconductor substrate 420 may be a light-receiving surface on which light is incident and a photoelectric conversion region 441 is exposed.

The semiconductor substrate 420 may include the photoelectric conversion region 441, and the photoelectric conversion region 441 may have a second conductivity type. For example, the second conductivity type may be n-type. A photovoltaic device PD may be formed by PN junction of the n-type photoelectric conversion region 441 and the p-type substrate 420.

The semiconductor substrate 420 may include a P-type barrier PB. The p-type barrier PB may be positioned to be spaced apart from the photoelectric conversion region 441 by a certain distance. For example, each P-type barrier PB may be formed to be spaced apart from each photoelectric conversion region 441 in the first direction X and the second direction Y. Additionally, the p-type barrier PB may extend in the third direction Z along the photoelectric conversion region 441. That is, the p-type barrier PB may be formed vertically within the semiconductor substrate 420. The p-type barrier PB may be doped with p-type impurities.

The isolation pattern 421 may be positioned on an outer surface of the semiconductor substrate 420 or between the pixels. The isolation pattern 421 may be, e.g., an insulating material made of an oxide, a nitride, an oxynitride or a combination thereof. In some implementations, the isolation pattern 421 may be formed to include a conductive material layer and a cover insulating layer surrounding the conductive material layer. For example, the conductive material layer may include polysilicon, metal, or an oxide such as metal nitride or SiO₂, and the cover insulating layer may include an oxide, a nitride, an oxynitride, or a combination thereof.

The isolation pattern 421 may be positioned within the semiconductor substrate 420. The isolation pattern 421 may define a plurality of unit pixels. The unit pixels may be arranged two-dimensionally in a plan view. For example, the isolation pattern 421 may be formed in a grid shape in a plan view to separate the unit pixels from each other. The isolation pattern 421 may be formed by filling an insulating material in a deep trench formed by patterning the semiconductor substrate 420.

In some implementations, the isolation pattern 421 may include an insulating spacer layer 422 and a conductive filling pattern 423. The insulating spacer layer 422 may extend conformally along a side surface of the trench within the semiconductor substrate 420. The conductive filling pattern 423 may be formed on the insulating spacer layer 422 to fill a portion of the trench within the semiconductor substrate 420.

In some implementations, the isolation pattern 421 may be a frontside deep trench isolation (FDTI) pattern.

In FIG. 21, an example is illustrated where the isolation pattern 421 is an FDTI pattern extending through the substrate 110 from a first surface SF1 to a second surface SF2 of the semiconductor substrate 420, but the present disclosure is not limited thereto, and the isolation pattern 421 may be a backside deep trench isolation (BDTI) pattern.

The insulating layer 430 may include a first transmission transistor TX1, a drain transistor DRX1, and a reset transistor RX1.

In some implementations, the first transmission transistor TX1 may be positioned on first surface SF1 of the semiconductor substrate 420. In FIG. 21, the floating diffusion region FD may be positioned at a first side of the first transmission transistor TX1, and a drain transistor DRX1 may be positioned at a second side of the first transmission transistor TX1.

In some implementations, the first transmission transistor TX1 may be implemented as a vertical transfer gate (VTG) structure.

The first transmission transistor TX1 may transfer a sensing signal (charge) generated in the corresponding photoelectric conversion region 441 to a floating diffusion region. An impurity region corresponding to a source/drain of the transmission transistor according to some embodiments may be the floating diffusion FD.

The transmission transistor TX1 may include a gate insulating layer 442, a gate electrode 443, and a gate spacer 444. The gate insulating layer 442 may be formed along a trench formed in the semiconductor substrate 420. The gate electrode 443 may fill a region defined by the gate insulating layer 442 and the gate spacer 444.

The gate electrode 443 may serve as a gate of the first transmission transistor TX1. For example, the gate electrode 443 may include a metal, such as poly-silicon (Poly-Si) or tungsten (W) and/or a conductive metal nitride.

In FIG. 21, the gate electrode 443 of the first transmission transistor TX1 is shown as having an oxide layer of a same thickness at opposite sides, but opposite sides of the gate electrode 443 may have oxide layers of different thicknesses.

The drain transistor DRX1 may be positioned on the first surface SF1 of the semiconductor substrate 420. In some implementations, the drain transistor DRX1 may transfer photoelectric charges generated in the corresponding photoelectric conversion region 441 to a power supply voltage region. The drain transistor DRX1 may be positioned at an opposite side of the reset transistor RX1 with respect to the transmission transistor RX1. For example, the drain transistor DRX1 may be positioned spaced apart from the transmission transistor RX1 in the first direction. The reset transistor RX1 may be positioned spaced apart from the transmission transistor RX1 in the second direction.

Accordingly, the drain transistor DRX1 may control the photoelectric charge generated by the photoelectric conversion region 441 without affecting a charge of the floating diffusion FD.

The drain transistor DRX1 may include a gate insulating layer 452, a gate electrode 453, and a gate spacer 454. The gate insulating layer 452 may be formed along a trench formed in the semiconductor substrate 420. The gate electrode 453 may fill a region defined by the gate insulating layer 452 and the gate spacer 454.

The gate electrode 453 may serve as a gate of the drain transistor DRX1. For example, the gate electrode 453 may include a metal such as poly-silicon (Poly-Si) or tungsten (W) and/or a conductive metal nitride.

In FIG. 21, the gate electrode 243 of the drain transistor DRX1 shown as having an oxide layer of a same thickness at opposite sides, but opposite sides of the gate electrode 243 may have oxide layers of different thicknesses.

The reset transistor RX1 may be positioned on the first surface SF1 of the semiconductor substrate 420. In some implementations, the reset transistor RX1 may transfer photoelectric charges generated in the corresponding photoelectric conversion region 441 to a power supply voltage region.

The reset transistor RX1 may include a gate insulating layer 462, a gate electrode 463, and a gate spacer 464. The gate insulating layer 462 may be formed along a trench formed in the semiconductor substrate 420. The gate electrode 463 may fill a region defined by the gate insulating layer 462 and the gate spacer 464.

The gate electrode 463 may serve as a gate of the reset transistor RX1. For example, the gate electrode 463 may include a metal, such as poly-silicon (Poly-Si) or tungsten (W) and/or a conductive metal nitride.

In FIG. 21, the gate electrode 463 of the reset transistor RX1 is shown as having an oxide layer of a same thickness at opposite sides, but opposite sides of the gate electrode 463 may have oxide layers of different thicknesses.

The second metal layers ML2_1 and ML2_2 may be formed in the insulating layer 430 and may extend in the first direction X or the second direction Y. The second metal layers ML2_1 to ML2_3 may be sequentially disposed from the first surface SF1 of the semiconductor substrate 420 where the second transistor TR2 is positioned. For example, the second_1 metal layer ML2_1 may be positioned closest to the transmission transistor TX1, and the second_2 metal layer ML2_3 may be positioned farthest from the transmission transistor TX1. Each thickness of the second metal layers ML2_1 and ML2_3 may be the same, but embodiments according to the technical idea of the present disclosure are not limited thereto. In FIG. 21, two second metal layers ML2_1 and ML2_3 are illustrated, but the present disclosure is not limited thereto, and a plurality of second metal layers ML2_1 and ML2_2 may be provided.

The second metal layers ML2_1 and ML2_3 may be connected by a plurality of second contacts C2_1 and C2_3. For example, the second metal layer ML2_1 may be connected to the second metal layer ML2_2 by a second_1 contact C2_1 extending in the third direction Z.

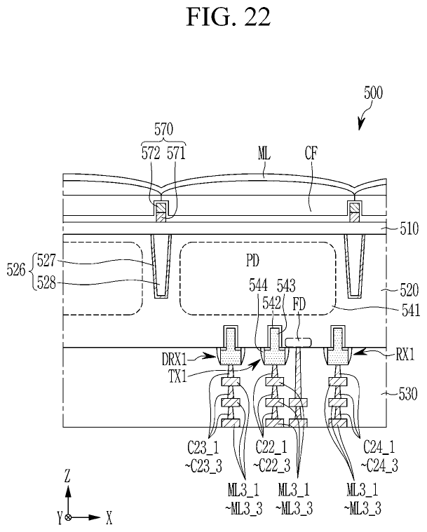

FIG. 22 illustrates schematic cross-sectional view of the pixel of FIG. 20 according to some implementations. Specifically, FIG. 22 illustrates a cross-sectional view of a pixel Pxa taken along a line A-A′ of FIG. 20.

In FIG. 22, a pixel array 500 may include a micro lens ML, a color filter layer CF, a surface insulating layer 510, a semiconductor substrate 520, an isolation pattern 526, and an insulating layer 530.

Unless otherwise stated, referring to FIG. 21, details on each of the micro lens ML, the color filter layer CF, the surface insulating layer 410, the semiconductor substrate 420, and the insulating layer 430 may be applied equally or similarly to a micro lens ML, a color filter layer CF, a surface insulating layer 510, a semiconductor substrate 250, and an insulating layer 530 in FIG. 22.

The isolation pattern 526 may be positioned on an outer surface of the semiconductor substrate 520 or between the pixels. The separation pattern 526 may be, e.g., an insulating material made of an oxide, a nitride, an oxynitride or a combination thereof. In some implementations, the isolation pattern 526 may be formed to include a conductive material layer and a cover insulating layer surrounding the conductive material layer. For example, the conductive material layer may include polysilicon, metal, or an oxide such as metal nitride or SiO₂, and the cover insulating layer may include an oxide, a nitride, an oxynitride, or a combination thereof.

The isolation pattern 526 may be positioned within the semiconductor substrate 520. In some implementations, the isolation pattern 526 may include an insulating spacer layer 527 and a conductive filling pattern 528. The insulating spacer layer 527 may extend conformally along a side surface of the trench within the semiconductor substrate 520. The conductive filling pattern 528 may be formed on the insulating spacer layer 527 to fill a portion of the trench within the semiconductor substrate 520.

The isolation pattern 526 may be formed from a back surface of the semiconductor substrate 520. That is, a trench is formed on the back surface of the semiconductor substrate 520, an insulating spacer layer 526 is formed in the formed trench, and a conductive filling pattern 527 is filled on the insulating spacer layer 526, thereby forming the isolation pattern 526. The isolation pattern 526 may not contact a front surface of the semiconductor substrate 520. Herein, the isolation pattern 526 may be a backside deep trench isolation (BDTI) pattern.

Meanwhile, the isolation pattern 526 may define a plurality of unit pixels. In some implementations, a plurality of unit pixels may be arranged across a plurality of isolation pattern 526. For example, a plurality of transistors SX1, RX1, DRX1, DCX1, TX1, SF10, and PC may be disposed below the isolation pattern 526.

The insulating layer 530 may include a first transmission transistor TX1, a drain transistor DRX1, and a reset transistor RX1.

In some implementations, the floating diffusion region FD may be positioned at a first side of the first transmission transistor TX1, and a drain transistor DRX1 may be positioned at a second side of the first transmission transistor TX1.

In some implementations, the first transmission transistor TX1 may be implemented as a vertical transfer gate (VTG) structure.

The first transmission transistor TX1 may transfer a sensing signal (charge) generated in the corresponding photoelectric conversion region 541 to a floating diffusion region. An impurity region corresponding to a source/drain of the transmission transistor according to some implementations may be the floating diffusion FD.

The transmission transistor TX1 may include a gate insulating layer 542, a gate electrode 543, and a gate spacer 544. The gate insulating layer 542 may be formed along a trench formed in the semiconductor substrate 520. The gate electrode 543 may fill a region defined by the gate insulating layer 542 and the gate spacer 544.

The gate electrode 543 may serve as a gate of the first transmission transistor TX1. For example, the gate electrode 543 may include a metal, such as poly-silicon (Poly-Si) or tungsten (W) and/or a conductive metal nitride.

In FIG. 22, the gate electrode 543 of the first transmission transistor TX1 is shown as having an oxide layer of a same thickness at opposite sides, but opposite sides of the gate electrode 543 may have oxide layers of different thicknesses.

In some implementations, the drain transistor DRX1 may transfer photoelectric charges generated in the corresponding photoelectric conversion region 541 to a power supply voltage region. The drain transistor DRX1 may be positioned at an opposite side of the reset transistor RX1 with respect to the transmission transistor RX1. For example, the drain transistor DRX1 may be positioned spaced apart from the transmission transistor RX1 in the first direction. The reset transistor RX1 may be positioned spaced apart from the transmission transistor RX1 in the second direction. Accordingly, the drain transistor DRX1 may control the photoelectric charge generated by the photoelectric conversion region 541 without affecting a charge of the floating diffusion FD.

The drain transistor DRX1 may include a gate insulating layer 552, a gate electrode 553, and a gate spacer 554. The gate insulating layer 552 may be formed along a trench formed in the semiconductor substrate 520. The gate electrode 553 may fill a region defined by the gate insulating layer 552 and the gate spacer 554.

The gate electrode 553 may serve as a gate of the drain transistor DRX1. For example, the gate electrode 553 may include a metal such as poly-silicon (Poly-Si) or tungsten (W) and/or a conductive metal nitride.

In FIG. 22, the gate electrode 553 of the drain transistor DRX1 shown as having an oxide layer of a same thickness at opposite sides, but opposite sides of the gate electrode 553 may have oxide layers of different thicknesses.

In some implementations, the reset transistor RX1 may transfer photoelectric charges generated in the corresponding photoelectric conversion region 541 to a power supply voltage region.

The reset transistor RX1 may include a gate insulating layer 562, a gate electrode 563, and a gate spacer 564. The gate insulating layer 562 may be formed along a trench formed in the semiconductor substrate 520. The gate electrode 563 may fill a region defined by the gate insulating layer 562 and the gate spacer 564.

The gate electrode 563 may serve as a gate of the reset transistor RX1. For example, the gate electrode 563 may include a metal, such as poly-silicon (Poly-Si) or tungsten (W) and/or a conductive metal nitride.

In FIG. 22, the gate electrode 563 of the reset transistor RX1 is shown as having an oxide layer of a same thickness at opposite sides, but opposite sides of the gate electrode 563 may have oxide layers of different thicknesses.

Third metal layers ML3_1 to ML3_3 may be formed in the insulating layer 530 and may extend in the first direction X or the second direction Y. The third metal layers ML3_1 to ML3_3 may be sequentially disposed from the first surface SF1 of the semiconductor substrate 520 where the second transistor TR2 is positioned. For example, the third_1 metal layer ML3_1 may be positioned closest to the transmission transistor TX1, and the third_3 metal layer ML3_3 may be positioned farthest from the transmission transistor TX1. Each thickness of the third metal layers ML3_1 and ML3_3 may be the same, but the present disclosure are not limited thereto. In FIG. 22, third metal layers ML3_1 to ML3_3 are illustrated, but the present disclosure is not limited thereto, and a plurality of third metal layers ML3_1 to ML3_3 may be provided.

The third metal layers ML3_1 to ML3_3 may be connected by multiple contacts C22_1 to C22_3, C23_1 to C23_3, and C24_1 to C24_3. For example, the first metal layer ML3_1 may be connected to the second metal layer ML3_2 by the contact C22_1 extending in the third direction Z.

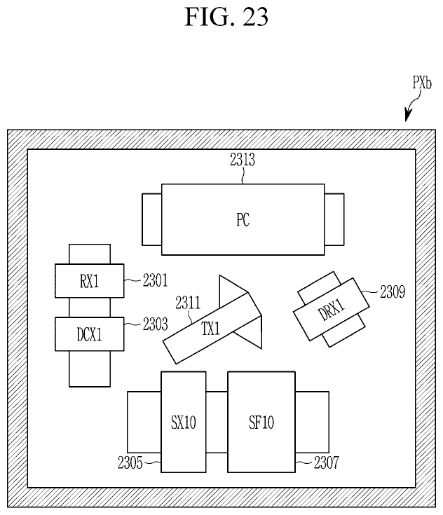

FIG. 23 illustrates a schematic top plan view of an example of a pixel according to some implementations. In FIG. 23, a pixel Pxb may include a plurality of transistors, e.g., a first reset transistor (RX1) 2301, a first gain control transistor (DCX1) 2303, a first select transistor (SX10) 2305, a first drive transistor (SF10) 2307, a drain transistor (DRX1) 2309, a first transmission transistor (TX1) 2311, and an image processing current transistor (PC) 2313. Herein, the image processing current transistor (PC) 2313 may be configured to generate a current used during image processing, that is, power required for a chip or circuit that processes image data to operate, and may include a precharge transistor PCX and a second precharge selection transistor PSX2 of FIG. 13.

While FIG. 23 may only illustrate an example in which multiple transistors can be arranged within a pixel Pxb, the present disclosure is not limited thereto, and multiple transistors within the pixel Pxb may be arranged in all possible cases. In addition, a gate of each of the multiple transistors within the pixel Pxb may have various shapes.

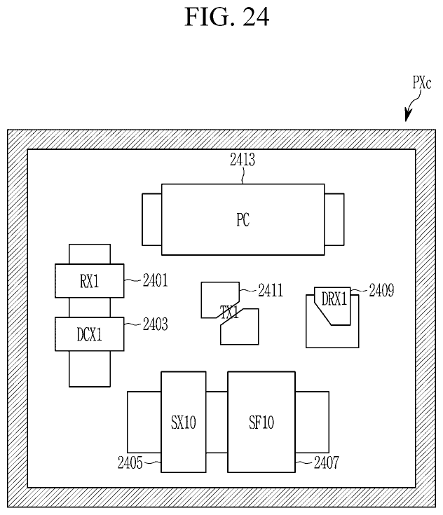

FIG. 24 illustrates a schematic top plan view of an example of a pixel according to some implementations. In FIG. 24, a pixel Pxc may include a plurality of transistors, e.g., a first reset transistor (RX1) 2401, a first gain control transistor (DCX1) 2403, a first select transistor (SX10) 2405, a first drive transistor (SF10) 2407, a drain transistor (DRX1) 2409, a first transmission transistor (TX1) 2411, and an image processing current transistor (PC) 2413. Herein, the image processing current transistor (PC) 2413 may be configured to generate a current used during image processing, that is, power required for a chip or circuit that processes image data to operate, and may include a precharge transistor PCX and a second precharge selection transistor PSX2 of FIG. 13.

FIG. 24 may only illustrate an example in which multiple transistors can be arranged within a pixel Pxc, and the present disclosure is not limited thereto, and multiple transistors within the pixel Pxc may be arranged in all possible cases. In addition, a gate of each of the multiple transistors within the pixel Pxc may have various shapes.

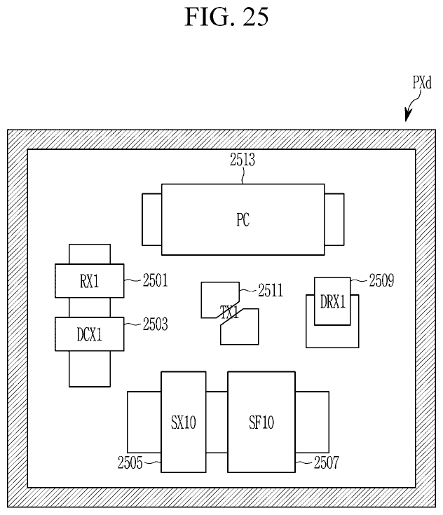

FIG. 25 illustrates a schematic top plan view of an example of a pixel according to some implementations. In FIG. 25, a pixel Pxd may include a plurality of transistors, e.g., a first reset transistor (RX1) 2501, a first gain control transistor (DCX1) 2503, a first select transistor (SX10) 2505, a first drive transistor (SF10) 2507, a drain transistor (DRX1) 2509, a first transmission transistor (TX1) 2511, and an image processing current transistor (PC) 2513. Herein, the image processing current transistor (PC) 2513 may be configured to generate a current used during image processing, that is, power required for a chip or circuit that processes image data to operate, and may include a precharge transistor PCX and a second precharge selection transistor PSX2 of FIG. 13.

FIG. 25 may only illustrate an example in which multiple transistors can be arranged within a pixel Pxd, and the present disclosure is not limited thereto, and multiple transistors within the pixel Pxd may be arranged in all possible cases. In addition, a gate of each of the multiple transistors within the pixel Pxd may have various shapes.

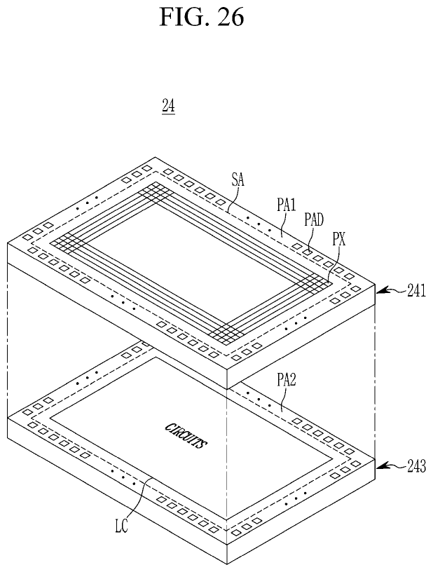

FIG. 26 illustrates a stack structure of an example of an image sensor according to some implementations. In FIG. 26, an image sensor 24 may include an upper chip 241 and a lower chip 243. The upper chip 241 may include a sensing area SA in which a plurality of pixels PX are provided, a circuit area LC in which elements for driving the pixels PX are provided, and a pad area PA around the sensing area SA and the circuit area LC. A plurality of upper pads PAD may be arranged in the chip pad area PA, and the upper pads PAD may be connected to elements provided on the lower chip 243 through vias, etc.

The lower chip 243 may include a circuit area LC, in which peripheral circuits of the pixel array 140 (in FIG. 1), such as a row driver 130, a readout circuit 150, a ramp signal generator 160, a timing controller 120, a data buffer 170, and an image signal processor 180 may be formed. In some implementations, the lower chip 243 may include a memory region and a dummy region. In the memory region, memory elements such as dynamic random access memory (DRAM) elements or static random access memory (SRAM) elements may be positioned. However, the present disclosure is not limited thereto, and any memory element may be positioned. The dummy region may have a function of supporting the upper chip 241 rather than storing data.

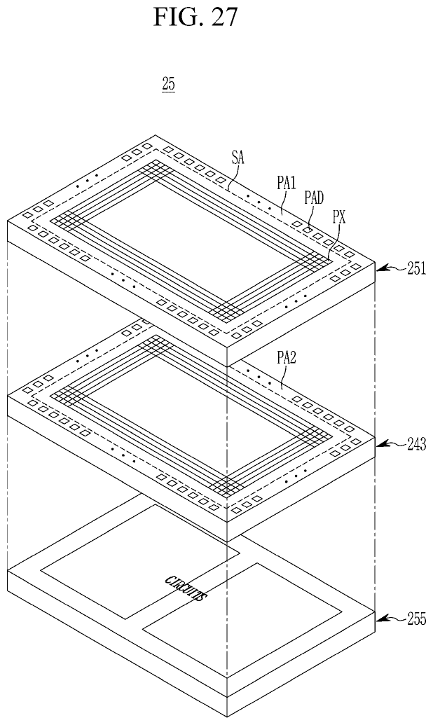

FIG. 27 illustrates a stack structure of an example of an image sensor according to some implementations. In FIG. 27, the image sensor 25 may include a plurality of stacked chips. For example, the pixel array 140 (in FIG. 1) may be formed on an upper chip 251 and a middle chip 253, and peripheral circuits or memory of the pixel array 140 may be formed on a lower chip 255.

The lower chip 255 may include a circuit area LC, in which peripheral circuits of the pixel array (FIG. 140) may be formed. In some implementations, the lower chip 255 may include a memory region and a dummy region.

In some implementations, the upper chip 251 and the middle chip 253 may be stacked on top of each other at a wafer level, and the lower chip 255 may be attached to a lower portion of the middle chip (253) at a chip level.

For example, referring to FIG. 5, the photoelectric charge generating circuit 501 may be positioned in the upper chip 251, and the sampling circuit 503 may be positioned in the middle chip 253.

For example, referring to FIG. 8, a photoelectric charge generating circuit 801, a first current source 8030 of a readout circuit 803, capacitors C11 and C12, and switches SW11 and SW12 may be positioned in the upper chip 251, a comparator 8031 and a counter circuit 8033 may be positioned in the middle chip 253, and a memory 8035 may be positioned in the lower chip 255.

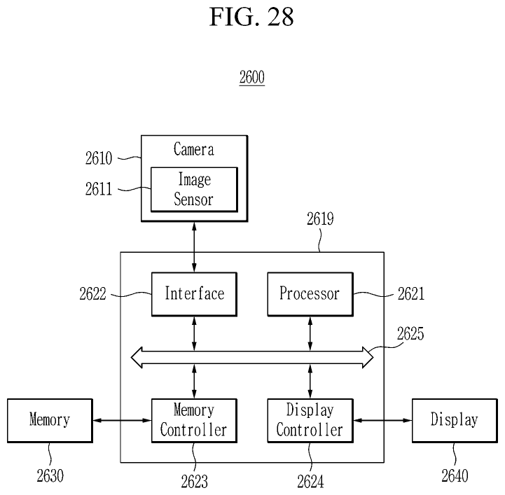

FIG. 28 illustrates an example block diagram of an example of a computing apparatus according to some implementations. In FIG. 28, the computing apparatus 2600 may include a camera 2610, a controller 2619, a memory 2630, and a display 2640.

The camera 2610 may include an image sensor 2611. The image sensor 2611 may be implemented as the image sensor described with reference to FIGS. 1 to 27. The camera 2610 may generate an image signal using an image sensor 2611, may perform image signal processing on an image signal, and may output the processed image signal to the controller 2619.

In some implementations, the image sensor 2611 may include a floating diffusion node and a transmission transistor positioned at a first side of the photoelectric device, and a drain transistor positioned at a second side of the photoelectric device. The image sensor 2611 may reset a photoelectric charge generated by the photoelectric device through the drain transistor. The image sensor 2611 may perform a shutter operation to reset the photoelectric charge generated by the photoelectric device during a period in which it samples the reset voltage accumulated in a floating diffusion node. Accordingly, the shutter operation may be performed regardless of an operation of the image sensor 2611, so a short integration period may be achieved and sensor performance may be maximized even during high-speed photographing. The image sensor 2611 may control the photoelectric charge accumulated in the floating diffusion node during an integration period to not become saturated through a short integration period.

The controller 2619 may include a processor 2621. The processor 2621 may control an overall operation of each component of the computing device 2600. The processor 2621 may be implemented as at least one of various processing units such as a central processing unit (CPU), an application processor (AP), and a graphics processing unit (GPU). In some implementations, the controller 2619 may be implemented as an integrated circuit (IC) or a system on chip (SoC).

In some implementations, as illustrated in FIG. 28, the controller 2619 may further include an interface 2622, a memory controller 2623, a display controller 2624, and a bus 2625. In some implementations, at least some of the interface 2622, the memory controller 2623, the display controller 2624, and the bus 2625 may be provided external to the controller 2619. In some implementations, the controller 2619 may further include an image signal processor.

The interface 2622 may transmit an image signal received from the image sensor 2611 to the memory controller 2623 or the display controller 2624 through the bus 2625.

The memory 2630 may store various data and commands. The memory controller 2623 may control transfer of data or commands to and from the memory 2630.

The display controller 2624 may transmit data to be displayed on the display 2640 to the display 2640 under the control of the processor 2621, and the display 2640 may display a screen according to the received data. In some implementations, the display 2640 may further include a touch screen. The touch screen may transmit user input to the controller 2619 that can control an operation of the computing apparatus 2600. The user input may be generated when a user touches a touch screen.

The bus 2625 may provide a communication function between components of the controller 2619. The bus 2625 may include at least one type of bus depending on communication protocol between components.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. An image sensor comprising:
a first photoelectric device configured to generate a photoelectric charge;
a first node configured to accumulate the photoelectric charge generated from the first photoelectric device;
a first transmission transistor connected between the first node and the first photoelectric device;
a first reset transistor connected between the first node and a power supply voltage;
a first drain transistor connected between the first photoelectric device and the power supply voltage; and
a driving transistor configured to generate, based on a voltage of the first node, a first pixel signal while the first transmission transistor is turned off, and a second pixel signal after the first transmission transistor is turned on, and
wherein the first drain transistor is configured to be turned on while the driving transistor generates the first pixel signal.

2. The image sensor of claim 1, wherein the first drain transistor is configured to be turned off before the first transmission transistor is turned on.

3. The image sensor of claim 1, wherein the driving transistor is configured to generate the second pixel signal based on a photoelectric charge generated by the first photoelectric device, wherein the first photoelectric device is configured to generate the photoelectric charge between a time the first drain transistor is off and a time the first transmission transistor is off.

4. The image sensor of claim 1, further comprising a first gain control transistor connected between the first node and the first reset transistor,
wherein the driving transistor is configured to generate a third pixel signal while the first gain control transistor is on, and
wherein the driving transistor is configured to generate a fourth pixel signal while the first gain control transistor is off.

5. The image sensor of claim 4,
wherein the second pixel signal includes a fifth pixel signal,
wherein the driving transistor is configured to generate the fifth pixel signal while the first gain control transistor is off, and
wherein the driving transistor is configured to generate a sixth pixel signal while the first gain control transistor is on.

6. The image sensor of claim 1, further comprising:
a second photoelectric device, the second photoelectric device and the first photoelectric device are covered with a single micro-lens;
a second transmission transistor connected between the first node and the second photoelectric device; and
a second drain transistor connected between the second photoelectric device and the power supply voltage,
wherein the first drain transistor and the second drain transistor are configured to be turned off before at least one of the first transmission transistor or the second transmission transistor is turned on.

7. The image sensor of claim 6,
wherein the first transmission transistor is configured to be turned on at a first time point, and the second transmission transistor is configured to be turned on at a second time point after the first time point, and
wherein the driving transistor is configured to generate a third pixel signal after the second transmission transistor is turned on.

8. The image sensor of claim 7, wherein the photoelectric device is configured to generate the second pixel signal based on a first photoelectric charge generated between a first time point at which the first drain transistor and the second drain transistor are off and a second time point at which the first transmission transistor is off.

9. The image sensor of claim 8, wherein the driving transistor is configured to generate the third pixel signal based on the first photoelectric charge and a second photoelectric charge generated by the second photoelectric device between the first time point and a time point at which the second transmission transistor is turned off.

10. An image sensor comprising:
a first photoelectric device configured to generate a photoelectric charge;
a first node configured to accumulate the photoelectric charge generated from the first photoelectric device;
a first transmission transistor connected between the first node and the photoelectric device;
a first reset transistor connected between the first node and a power supply voltage;
a first drain transistor connected between the first photoelectric device and a power supply voltage;
a driving transistor configured to generate a pixel signal in response to a voltage of the first node and output the pixel signal to the first output node;
a first sampling capacitor connected to the first output node and configured to store a charge corresponding to the pixel signal; and
a first sampling transistor connected between the first sampling capacitor and the first output node,
wherein the driving transistor is configured to generate a first pixel signal while the first transmission transistor is turned off, and to generate a second pixel signal after the first transmission transistor is turned on, and
wherein the first drain transistor is configured to be turned on while the first sampling capacitor stores a charge corresponding to the first pixel signal.

11. The image sensor of claim 10, wherein the first drain transistor is configured to be turned off before the first transmission transistor is turned on.

12. The image sensor of claim 10, wherein the second pixel signal is configured to be generated by the driving transistor based on a photoelectric charge generated between a time at which the first drain transistor is turned off and a time at which the first transmission transistor is turned off.

13. The image sensor of claim 10, further comprising:
a second sampling capacitor connected to the first output node, the second sampling capacitor configured to store a charge corresponding to the pixel signal; and
a second sampling transistor connected between the second sampling capacitor and the first output node,
wherein the second sampling capacitor is configured to store the second pixel signal after the first drain transistor is turned off.

14. The image sensor of claim 10, further comprising:
a first gain control transistor connected between the first node and the first reset transistor;
a second sampling capacitor connected to the first output node and configured to store a charge corresponding to the pixel signal;
a third sampling capacitor connected to the first output node and configured to store a charge corresponding to the pixel signal;
a fourth sampling capacitor connected to the first output node and configured to store a charge corresponding to the pixel signal;
a second sampling transistor connected between the second sampling capacitor and the first output node;
a third sampling transistor connected between the third sampling capacitor and the first output node; and
a fourth sampling transistor connected between the fourth sampling capacitor and the first output node.

15. The image sensor of claim 14,
wherein the first pixel signal includes a third pixel signal configured to be generated by the driving transistor while the first gain control transistor is turned on and a fourth pixel signal configured to be generated by the driving transistor while the first gain control transistor is turned off, and
wherein the first sampling capacitor is configured to store the third pixel signal and the second sampling capacitor is configured to store the fourth pixel signal.

16. The image sensor of claim 14,
wherein the second pixel signal includes a fifth pixel signal configured to be generated by the driving transistor while the first gain control transistor is turned off and a sixth pixel signal configured to be generated by the driving transistor while the first gain control transistor is turned on, and
wherein the third sampling capacitor is configured to store the fifth pixel signal and the fourth sampling capacitor is configured to store the sixth pixel signal.

17. The image sensor of claim 10, further comprising:
a second photoelectric device, wherein the second photoelectric device and the first photoelectric device are covered with a single micro-lens;
a second transmission transistor connected between the first node and the second photoelectric device; and
a second drain transistor connected between the second photoelectric device and the power supply voltage,
the first drain transistor and the second drain transistor are configured to be turned off before at least one of the first transmission transistor or the second transmission transistor is turned on.

18. The image sensor of claim 17, further comprising:
a second sampling capacitor connected to the first output node and configured to store a charge corresponding to the pixel signal;
a third sampling capacitor connected to the first output node and configured to store a charge corresponding to the pixel signal;
a second sampling transistor connected between the second sampling capacitor and the first output node; and
a third sampling transistor connected between the third sampling capacitor and the first output node,
wherein the first transmission transistor is configured to be turned on at a first time point, and the second transmission transistor is configured to be turned on at a second time point after the first time point,
wherein the driving transistor is configured to generate a third pixel signal after the second transmission transistor is turned on, and
wherein the second sampling capacitor is configured to store the second pixel signal, and the third sampling capacitor is configured to store the third pixel signal.

19. An image sensor comprising:
a pixel comprising
a first photoelectric device configured to generate a photoelectric charge,
a first node configured to accumulate the photoelectric charge generated by the first photoelectric device,
a first transmission transistor connected between the first node and the first photoelectric device,
a first reset transistor connected between the first node and a power supply voltage,
a first drain transistor connected between the first photoelectric device and the power supply voltage, and
a driving transistor configured to generate a pixel signal in response to a voltage of the first node to output the pixel signal to the first output node;
a ramp signal generator configured to generate a reference signal including a plurality of ramp signals; and
a readout circuit connected to the first output node and configured to compare the pixel signal and the reference signal, and generate image data based on a comparison result thereof,
wherein the driving transistor is configured to generate a first pixel signal while the first transmission transistor is turned off, and generate a second pixel signal after the first transmission transistor is turned on, and
wherein the first drain transistor is configured to be turned on while the readout circuit is configured to generate first image data corresponding to the first pixel signal.

20. The image sensor of claim 19, wherein the second pixel signal is generated by the driving transistor based on a photoelectric charge generated between a time at which the first drain transistor is turned off and a time at which the first transmission transistor is turned off.
